(19) United States
(12) Patent Application Publication
(10) Pub. No.: US 2025/0190719 A1
(43) Pub. Date: Jun. 12, 2025

(54) SYSTEM(S) AND METHOD(S) FOR UTILIZING GENERATIVE MODEL(S) TO GENERATE A PERSONALIZED INTERACTIVE SUMMARY OF CONTENT THAT IS INTERACTIVE

(71) Applicant: GOOGLE LLC, Mountain View, CA (US)

(72) Inventors: Mingpu Hu, San Francisco, CA (US); Calder Kitagawa, Durham, NC (US)

(21) Appl. No.: 18/537,585

(22) Filed: Dec. 12, 2023

(51) Int. Cl. G06F 40/58; G06N 3/08; H04L 67/50

(52) U.S. Cl. CPC G06F 40/58; G06N 3/08; H04L 67/535

(57) ABSTRACT

Implementations relate to utilizing generative model(s) to generate a personalized summary of content that is interactive. Processor(s) of a system can: select a plurality of sources of content to be utilized in generating the summary of the content, cause the summary of the content to be generated using the generative model(s), and cause the summary of the content to be rendered. In some implementations, the processor(s) can proactively determine to cause the summary of the content to be generated and rendered (e.g., based on one or more triggering criteria being satisfied). In other implementations, the processor(s) can reactively determine to cause the summary of the content to be generated and rendered (e.g., based on user input being received). In various implementations, while the summary of the content is being rendered, a user can interrupt the rendering of the summary of the content, and the processor(s) can handle the interruption accordingly.

### BACKGROUND

Various generative models have been proposed that can be used to process natural language (NL) content and/or other input(s), to generate output that reflects generative content that is responsive to the input(s). For example, large language models (LLM(s)) have been developed that can be used to process NL content and/or other input(s), to generate LLM output that reflects generative NL content and/or other generative content that is responsive to the input(s). These LLMs are typically trained on enormous amounts of diverse data including data from, but not limited to, webpages, electronic books, software code, electronic news articles, and machine translation data. Accordingly, these LLMs leverage the underlying data on which they were trained in performing these various NLP tasks. For instance, in performing a summarization generation task, these LLMs can process content, such as textual content of a web page, and generate a response that is a summary of the content.

However, in many instances, the summary of the content that is generated is in response to an explicit user input to generate the summary of the content and a user that provides the user input is required to provide the content to these LLMs. For example, the user may have to provide a link to the web page that includes the content, upload a document that includes the content, or otherwise provide some explicit indication of the content. Further, even in instances where the content is proactively provided to these LLMs (e.g., without some explicit indication of the content from the user), the content is typically determined based on context associated with the user and/or a user device of the user. For example, these LLMs can utilize a given interest of a user to obtain content that is relevant to the given interest, but the given interest may not be relevant to a task or action currently being undertaken by the user. Moreover, the summary of the content provided by these LLMs is typically not interactive in that it is provided as part of a turn-based dialog where the user must consume the entire summary of the content, then can ask certain follow-up questions. As a result, computational and network resources are unnecessarily consumed.

### SUMMARY

Implementations relate to utilizing generative model(s) to generate a personalized summary of content that is interactive. Processor(s) of a system can: select a plurality of sources of content to be utilized in generating the summary of the content, cause the summary of the content to be generated using the generative model(s), and cause the summary of the content to be rendered. In some implementations, the processor(s) can proactively determine to cause the summary of the content to be generated and rendered (e.g., based on one or more triggering criteria being satisfied). In other implementations, the processor(s) can reactively determine to cause the summary of the content to be generated and rendered (e.g., based on user input being received). In various implementations, while the summary of the content is being rendered, a user can interrupt the rendering of the summary of the content, and the processor(s) can handle the interruption accordingly. Notably, a type of the plurality of sources described herein can include, for example, two or more open tabs of a web browser, two or more news articles from news outlets, two or more documents provided by a user, two or more search result document(s), and/or other content.

In implementations where the processor(s) proactively determine to cause the summary of the content to be generated and rendered, the processor(s) can select the plurality of sources based on which of the one or more triggering criteria that are satisfied. Further, the processor(s) can process, using a large language model (LLM) or another generative model capable of performing a summarization task, LLM input that includes at least the plurality of sources to generate LLM output, and can generate the summary of the content based on the LLM output. The processor(s) can then cause the summary of the content to be visually rendered via a client device of a user and/or audibly rendered via speaker(s) of the client device of the user. In some implementations, a length of the summary of the content and/or a duration of time over which the summary is to be rendered can be inferred based on one or more signals (e.g., calendar availability, predicted commute time, etc.).

For example, assume that a user is interacting with a web browser application at a client device, and assume that the web browser application has two or more open tabs that are related to the same topic. Further assume that the one or more triggering criteria include a topic criterion that indicates a given topic of the two or more open tabs of the web browser satisfies a similarity threshold. In this example, the two or more open tabs that are related to the same topic are likely to satisfy the similarity threshold for the given topic. Further assume that the user has a meeting in 10 minutes as indicated by a work calendar. Accordingly, the processor(s) can determine to proactively cause the summary of the content to be generated and rendered in a 10 minute or less time frame. Although the above example is described with respect to one or more triggering conditions including a topic criterion, it should be understood that is not meant to be limiting and that other triggering criteria are contemplated here, such as a quantity criterion, an interaction criterion, a temporal criterion, a situational criterion, and/or other criterion. Further, it should be understood that the one or more triggering criteria may vary based on the type of the plurality of sources of the content as described herein.

By proactively determining to cause the summary of the content to be generated and rendered as described herein, one or more technical advantages can be achieved. As one non-limiting example, by not only utilizing the one or more triggering criteria to determine when to cause the summary of the content to be generated and rendered, but by also utilizing the one or more triggering criteria to determine which of a plurality of sources should be selected for utilization in generating the summary of the content, the processor(s) can cause the summary of the content to be rendered at a time the user is likely to consume the summary of the content and include content that is contextually relevant to the user. Accordingly, the user need not consume each of the plurality of sources one-by-one, which can prolong a human-to-machine interaction. As a result, battery life of the client device can be conserved since the user need not consume each of the plurality of sources one-by-one, which in the aggregate, will take a longer duration of time to consume. Further, computational and/or network resources consumed by the client device can be conserved since the user need not consume each of the plurality of sources one-by-one, which in the aggregate, will take a longer duration of time to consume and require more user inputs. Moreover, in implementations where the client device has various hardware constraints (e.g., a reduced display size of a mobile device as compared to other client devices, such as a laptop or desktop), the user may not be able to consume multiple of the plurality of sources at a given instance of time. As a result, the user need not navigate from resource to resource, thereby reducing a quantity of inputs received at the client device and conserving computational resources.

In implementations where the processor(s) reactively determine to cause the summary of the content to be generated and rendered, the processor(s) can select the plurality of sources based on the user input. Further, the processor(s) can process, using the LLM or another generative model capable of performing a summarization task, LLM input that includes at least the plurality of sources to generate LLM output, and can generate the summary of the content based on the LLM output. The processor(s) can then cause the summary of the content to be visually rendered via a client device of a user and/or audibly rendered via speaker(s) of the client device of the user. In some implementations, a length of the summary of the content and/or a duration of time over which the summary is to be rendered can be specified by the user input or additional user input.

For example, assume that a user is interacting with a generative radio application at a client device, and assume that the generative radio station includes various generative radio stations directed to different topics. Further assume that the user selects a given radio station that is associated with a given topic, such as a “gaming” topic. In this example, news articles, game reviews, or other content associated with the “gaming” topic. Moreover, the user can specify a duration of time for the generative radio session (e.g., 15 minutes, 30 minutes, etc.), which can influence a quantity of sources that are selected and/or how robust each source is summarized in the summary of the content. Accordingly, the processor(s) can determine to reactively cause the summary of the content to be generated and rendered for the length and/or duration of time specified by the user.

By reactively determining to cause the summary of the content to be generated and rendered as described herein, one or more technical advantages can be achieved. As one non-limiting example, by not only enabling the user to specify not only the plurality of resources to be utilized in generating the summary of the content (or a topic of the plurality of resources to be utilized in generating), but also the duration of time over the summary which the summary of the content is to be rendered and/or a length of the summary of the content to be rendered, the processor(s) guide the human-to-machine interaction. For instance, while the user may specify the plurality of resources and the duration and/or length of the summary of the content, the processor(s) can determine how robust the summary of the content (or each how robust each resource in the summary of the content) is given various parameters specified by the user, and without the user having to explicitly provide this robustness. Further, and similarly as described above, the user need not consume each of the plurality of sources one-by-one, which can prolong a human-to-machine interaction. As a result, battery life of the client device can be conserved since the user need not consume each of the plurality of sources one-by-one, which in the aggregate, will take a longer duration of time to consume. Further, computational and/or network resources consumed by the client device can be conserved since the user need not consume each of the plurality of sources one-by-one, which in the aggregate, will take a longer duration of time to consume and require more user inputs. Moreover, in implementations where the client device has various hardware constraints (e.g., a reduced display size of a mobile device as compared to other client devices, such as a laptop or desktop), the user may not be able to consume multiple of the plurality of sources at a given instance of time. As a result, the user need not navigate from resource to resource, thereby reducing a quantity of inputs received at the client device and conserving computational resources.

In implementations where the user interrupts the rendering of the summary of the content, the processor(s) can receive user input that interrupts the rendering of the summary of the content. In response to receiving the user input that interrupts the rendering of the summary of the content, the processor(s) can halt the rendering of the summary of the content, generate a response that is responsive to the user input, cause the response to be rendered, and then resume the rendering of the summary of the content. In some implementations, the processor(s) can continue rendering a current portion of the summary of the summary of the content prior to halting the rendering of the summary of the content. In some versions of these implementations, the processor(s) can bookmark a next portion of the summary of the content, that follows the current portion of the summary of the content, to enable the processor(s) to resume the rendering of the summary of the content at the next portion. However, the processor(s) may determine to re-generate and/or omit one or more remaining portions (if any) of the summary of the content that follow the next portion and based on the user input and/or the response that is responsive to the user input.

Continuing with the above example where the user selects the given radio station that is associated with the “gaming” topic, further assume that, while the summary of the content is being rendered, the user provides user input (e.g., spoken input, typed input, touch input, etc.) that requests weather content. In this example, the processor(s) can halt rendering of the summary of the content for the gaming “topic”, generate a response that includes the weather content associated with a location of the user, and cause the response that includes the weather content to be rendered. In this example, the user input that requests the weather content is unlikely to correspond to the next portion or any remaining portions of the summary of the content for the “gaming” topic. Accordingly, the processor(s) will likely resume the rendering of the next portion of the summary of the content for the “gaming” topic and without modifying any next portion or remaining portion of the summary of the content for the “gaming” topic. In contrast, further assume that, while the summary of the content is being rendered, the user provides user input (e.g., spoken input, typed input, touch input, etc.) that requests additional content for a particular game that is being discussed in the summary of the content, such as content related to a most recently released trailer for the particular game, a release date for the particular game, or the like. In this example, the processor(s) can halt rendering of the summary of the content for the gaming “topic”, generate a response that includes the requested content, and cause the response to be rendered. In this example, the user input that requests the additional content for the particular game could correspond to the next portion or a remaining portion of the summary of the content for the “gaming” topic. Accordingly, the processor(s) can re-generate the next portion or the remaining portion of the summary of the content or omit the next portion or the remaining portion of the summary, and then resume the rendering of the summary of the content as modified.

By enabling the user to interrupt the rendering of the summary of the content as described herein, one or more technical advantages can be achieved. As one non-limiting example, in some instances of halting and resuming the rendering of the summary of the content when the user interrupts the rendering of the summary of the content, the processor(s) can handle the user input and then resume the rendering of the summary of the content and without having to re-prompt the LLM or another generative model by resuming the rendering from the next portion of the summary of the content. As a result, computational and/or network resources can be conserved by not having to re-prompt the LLM or another generative model. Further, in other instances of halting and resuming the rendering of the summary of the content when the user interrupts the rendering of the summary of the content, the processor(s) can handle the user input and then resume the rendering of the summary of the content with a modified version of the summary of the content that does not duplicate anything from the user input and/or the response that is responsive to the user input. As a result, the human-to-machine interaction can be concluded in a more quick and efficient manner since the modified version of the summary of the content does not repeat anything from the user input and/or the response that is responsive to the user input. Moreover, the user need not wait for the rendering of the summary of the content to be complete or cancel the rendering of the summary of the content to provide the user input. As a result, the human-to-machine interaction can be concluded in a more quick and efficient manner since the user can cause the rendering of the summary of the content to be halted and resumed as desired.

The above description is provided as an overview of some implementations of the present disclosure. Further description of those implementations, and other implementations, are described in more detail below.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts a flowchart illustrating an example method of proactively generating and rendering a summary of content, in accordance with various implementations.

FIG. 3 depicts a flowchart illustrating an example method of reactively generating and rendering a summary of content, in accordance with various implementations.

FIG. 4 depicts a flowchart illustrating an example method of handling interruptions during rendering of a summary of content, in accordance with various implementations.

FIG. 5A, FIG. 5B, FIG. 5C, FIG. 5D, FIG. 5E, and FIG. 5F depict various non-limiting examples of proactively generating and rendering a summary of content, in accordance with various implementations.

FIG. 6A, FIG. 6B, FIG. 6C, and FIG. 6D depict various non-limiting examples of reactively generating and rendering a summary of content and handling interruptions during rendering of the summary of the content, in accordance with various implementations.

FIG. 7 depicts an example architecture of a computing device, in accordance with various implementations.

### DETAILED DESCRIPTION OF THE DRAWINGS

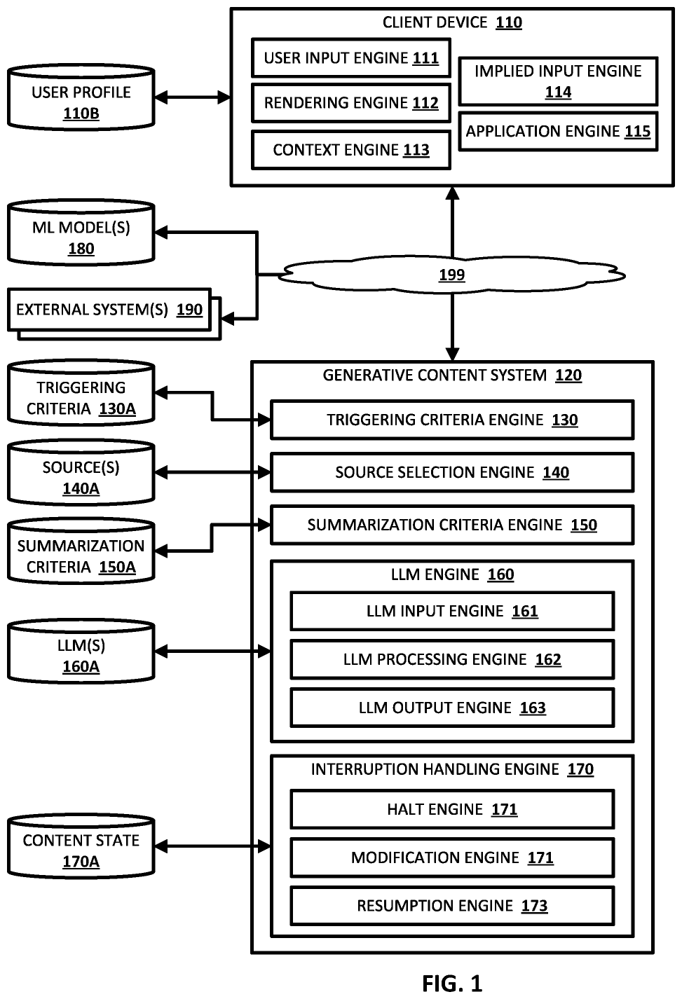

Turning now to FIG. 1, a block diagram of an example environment that demonstrates various aspects of the present disclosure, and in which implementations disclosed herein can be implemented is depicted. The example environment includes a client device 110 and a generative content system 120. In some implementations, all or aspects of the generative content system 120 can be implemented locally at the client device 110. In additional or alternative implementations, all or aspects of the generative content system 120 can be implemented remotely from the client device 110 as depicted in FIG. 1 (e.g., at remote server(s)). In those implementations, the client device 110 and the generative content system 120 can be communicatively coupled with each other via one or more networks 199, such as one or more wired or wireless local area networks (“LANs,” including Wi-Fi®, mesh networks, Bluetooth®, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more software applications, via application engine 115, through which touch inputs and/or NL based input can be submitted and/or a summary of content that is responsive to the touch inputs and/or the NL based input can be rendered (e.g., audibly and/or visually). The application engine 115 can execute one or more software applications that are separate from an operating system of the client device 110 (e.g., one installed “on top” of the operating system)—or can alternatively be implemented directly by the operating system of the client device 110. For example, the application engine 115 can execute a web browser, generative radio, or automated assistant installed on top of the operating system of the client device 110. As another example, the application engine 115 can execute a web browser software application, a generative radio software application, or automated assistant software application that is integrated as part of the operating system of the client device 110. The application engine 115 (and the one or more software applications executed by the application engine 115) can interact with or otherwise provide access to (e.g., as a front-end) the generative content system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to typed and/or touch inputs directed to the client device 110.

In some versions of those implementations, the client device 110 can utilize one or more machine learning (ML) model(s) stored in ML model(s) database 180 to process the user input. For example, the user input received at the client device 110 may be a spoken utterance. In these examples, the user input engine 111 can process, using automatic speech recognition (ASR) model(s) stored in the ML model(s) database 180 (e.g., a recurrent neural network (RNN) model, a transformer model, and/or any other type of ML model capable of performing ASR), audio data that capture the spoken utterance and that is generated by microphone(s) of the client device 110 to generate ASR output. The ASR output can include, for example, speech hypotheses (e.g., term hypotheses and/or transcription hypotheses) that are predicted to correspond to the spoken utterance captured in the audio data, one or more corresponding predicted values (e.g., probabilities, log likelihoods, and/or other values) for each of the speech hypotheses, a plurality of phonemes that are predicted to correspond to the spoken utterance captured in the audio data, one or more corresponding predicted values (e.g., probabilities, log likelihoods, and/or other values) for each of the plurality of phonemes, and/or other ASR output. In these implementations, the user input engine 111 can select one or more of the speech hypotheses as recognized text that corresponds to the spoken utterance (e.g., based on the corresponding predicted values for each of the speech hypotheses), such as when the user input engine 111 utilizes an end-to-end ASR model. In other implementations, the user input engine 111 can select one or more of the predicted phonemes (e.g., based on the corresponding predicted values for each of the predicted phonemes), and determine recognized text that corresponds to the spoken utterance based on the one or more predicted phonemes that are selected, such as when the user input engine 111 utilizes an ASR model that is not end-to-end. In these implementations, the user input engine 111 can optionally employ additional mechanisms (e.g., a directed acyclic graph) to determine the recognized text that corresponds to the spoken utterance based on the one or more predicted phonemes that are selected.

In various implementations, the client device 110 can include a rendering engine 112 that is configured to render a summary of content for audible and/or visual presentation to a user of the client device 110 using one or more user interface output devices. For example, the client device 110 can be equipped with speaker(s) that enable the summary of the content to be rendered as audible content via the client device 110. Additionally, or alternatively, the client device 110 can be equipped with a display or projector that enables the summary of the content to be rendered as textual content, and optionally along with other visual content (e.g., image(s), video(s), etc.), via the client device 110.

In some versions of those implementations, the client device 110 can utilize one or more of the ML model(s) stored in the ML model(s) database 180 to process the summary of the content. For example, and as noted above, the summary of the content can be audibly rendered as audible content via the speaker(s) of the client device 110. In these examples, the user input engine 111 can process, using text-to-speech (TTS) model(s) stored in the ML model(s) database 180 (e.g., the summary of the content generated using the generative content system 120) to generate synthesized speech audio data that includes computer-generated synthesized speech capturing the summary of the content. In implementations where the rendering engine 112 utilizes the TTS model(s) to process the summary of the content, the rendering engine 112 can generate the synthesized speech using one or more prosodic properties (e.g., that define a tone, pitch rhythm, speed, etc. of the computer-generated synthesized speech) to reflect different personas and/or speaking styles. In these implementations, the user can optionally provide an indication of the one or more prosodic properties, the different personas, and/or the speaking styles to be utilized in generating the computer-generated synthesized speech.

Notably, although the ML model(s) stored in the ML model(s) database 180 are described above as being implemented locally by the client device 110, it should be understood that is for the sake of example and is not meant to be limiting. For instance, the audio data that captures the spoken utterance can additionally, or alternatively, be streamed to the generative content system 120, and the generative content system 120 can utilize the ASR model(s) stored in the ML model(s) database 180 (or separate cloud-based ASR model(s)) to generate the ASR output. Also, for instance, the summary of the content can be additionally, or alternatively, be processed by the generative content system 120 utilizing the TTS model(s) stored in the ML models) database 180 (or separate cloud-based TTS model(s)) to generate the synthesized speech audio data, and the synthesized speech audio data can be streamed to the client device 110 (or an additional client device of the user) to cause the synthesized speech audio date to audibly rendered for presentation to the user of the client device 110.

In various implementations, the client device 110 can include a context engine 113 that is configured to determine a client device context (e.g., current or recent context) of the client device 110 and/or a user context of a user of the client device 110 (or an active user of the client device 110 when the client device 110 is associated with multiple users). In some of those implementations, the context engine 113 can determine a context based on data stored in user profile database 110B. The data stored in the user profile database 110B can include, for example, user interaction data that characterizes current or recent interaction(s) of the client device 110 and/or a user of the client device 110, location data that characterizes a current or recent location(s) of the client device 110 and/or a geographical region associated with a user of the client device 110, user attribute data that characterizes one or more attributes of a user of the client device 110, user preference data that characterizes one or more preferences of a user of the client device 110, and/or any other data accessible to the context engine 113 via the user profile database 110B or otherwise.

For example, the context engine 113 can determine a current context based on a current state of a dialog session (e.g., considering one or more recent NL based inputs provided by a user during the dialog session) and/or a current location of the client device 110. For instance, the context engine 113 can determine a current context of “visitor looking for upcoming events in Louisville, Kentucky” based on a recently issued query and an anticipated future location of the client device 110 (e.g., based on recently booked hotel accommodations). As another example, the context engine 113 can determine a current context based on which software application is active in the foreground of the client device 110, a current or recent state of the active software application, and/or content currently or recently rendered by the active software application. A context determined by the context engine 113 can be utilized, for example, in supplementing or rewriting user input that is received at the client device 110, in generating an implied user input (e.g., an implied query or prompt formulated independent of any explicit user input provided by a user of the client device 110), and/or in determining to submit an implied user input and/or to render result(s) (e.g., a summary of content) for an implied user input.

In various implementations, the client device 110 can include an implied input engine 114 that is configured to: generate an implied user input independent of any user explicit user input provided by a user of the client device 110; submit an implied user input, optionally independent of any user explicit user input that requests submission of the implied user input; and/or cause rendering of a summary of content or other response for the implied user input, optionally independent of any explicit user input that requests rendering of the summary of the content or the response. For example, the implied input engine 114 can use one or more past or current contexts, from the context engine 113, in generating an implied user input, determining to submit the implied user input, and/or in determining to cause rendering of a summary of content or a response that is responsive to the implied user input. For instance, the implied input engine 114 can automatically generate and automatically submit an implied query or implied prompt based on the one or more past or current contexts. Further, the implied input engine 114 can automatically push the summary of the content or the response that is generated responsive to the implied query or implied prompt to cause them to be automatically rendered or can automatically push a notification of the summary of the content or the response, such as a selectable notification that, when selected, causes rendering of the summary of the content or the response. Additionally, or alternatively, the implied input engine 114 can submit respective implied user input at regular or non-regular intervals and cause respective summaries of content or respective responses to be automatically provided (or a notification thereof automatically provided). For instance, the implied NL based input can be “patent news” based on the one or more past or current contexts indicating a user's general interest in patents, the implied user input or a variation thereof periodically submitted, and the respective summaries of the content or the respective responses can be automatically provided (or a notification thereof automatically provided). It is noted that the respective summaries of the content or the response can vary over time in view of, e.g., presence of new/fresh search result document(s) over time.

Further, the client device 110 and/or the generative content system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household, a workplace, a hotel, etc.).

The generative content system 120 is illustrated in FIG. 1 as including a triggering criteria engine 130, a source selection engine 140, a summarization criteria engine 150, a large language model (LLM) 160, and an interruption handling engine 170. Some of these engines can be combined and/or omitted in various implementations. Further, these engines can include various sub-engines. For instance, the LLM engine 160 is illustrated in FIG. 1 as including a LLM input engine 131, a LLM processing engine 132, and a LLM output engine 163. Further, the interruption handling engine 170 is illustrated in FIG. 1 as including a halt engine 171, a modification engine 172, and a resumption engine 173. Similarly, some of these sub-engines can be combined and/or omitted in various implementations. Accordingly, it should be understood that the various engines and sub-engines of the generative content system 120 illustrated in FIG. 1 are depicted for the sake of describing certain functionalities and is not meant to be limiting.

Further, the generative content system 120 is illustrated in FIG. 1 as interfacing with various databases, such as triggering criteria database 130A, source(s) database 140A, summarization criteria database 150A, LLM(s) database 160A, and content state database 170A. Although particular engines and/or sub-engines are depicted as having access to particular databases, it should be understood that is for the sake of example and is not meant to be limiting. For instance, in some implementations, each of the various engines and/or sub-engines of the generative content system 120 may have access to each of the various databases. Further, some of these databases can be combined and/or omitted in various implementations. Accordingly, it should be understood that the various databases interfacing with the generative content system 120 illustrated in FIG. 1 are depicted for the sake of describing certain data that is accessible to the generative content system 120 and is not meant to be limiting.

Moreover, the generative content system 120 is illustrated in FIG. 1 as interfacing with other system(s), such as external system(s) 190. The external system(s) can include, for example, search system(s) (e.g., text-based search system(s), image-based search system(s), video-based search system(s), etc.) and/or other generative system(s) (other text-based generative system(s), other image-based generative system(s), other video-based generative system(s), other audio-based generative system(s), etc.). In some implementations, the external system(s) 190 are first-party system(s), whereas in other implementations, the external system(s) 190 are third-party system(s). As used herein, the term “first-party” or “first-party entity” refers to an entity that controls, develops, and/or maintains the generative content system 120, whereas the term “third-party” or “third-party entity” refers to an entity that is distinct from the entity that controls, develops, and/or maintains the generative content system 120.

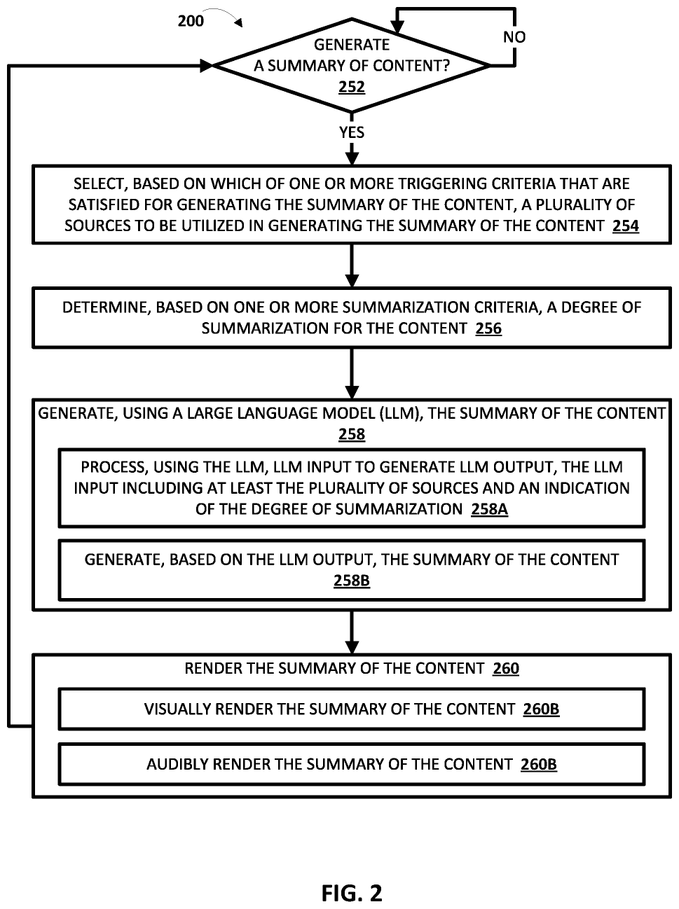

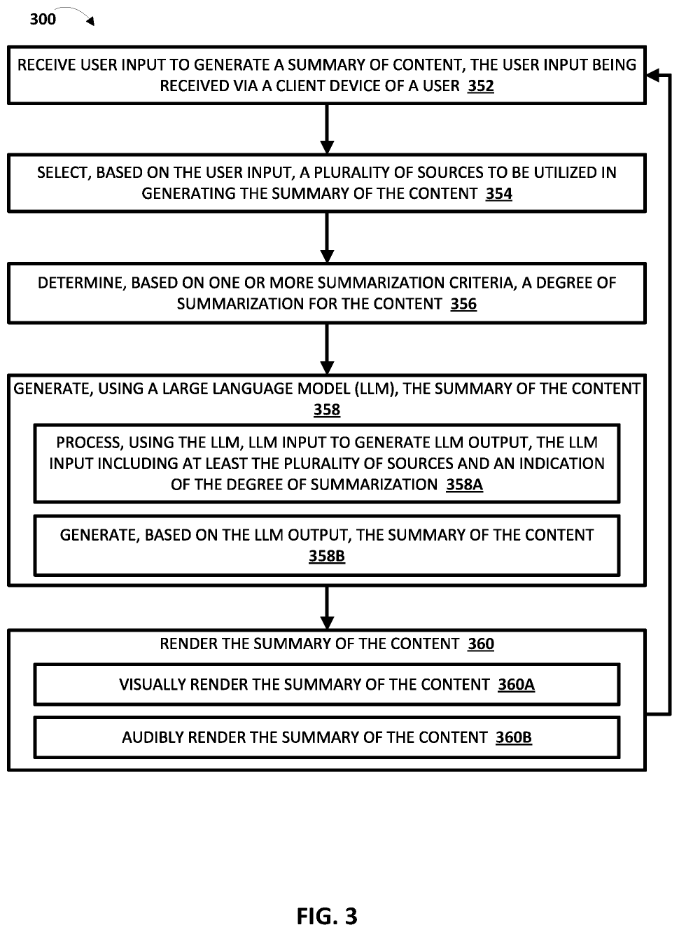

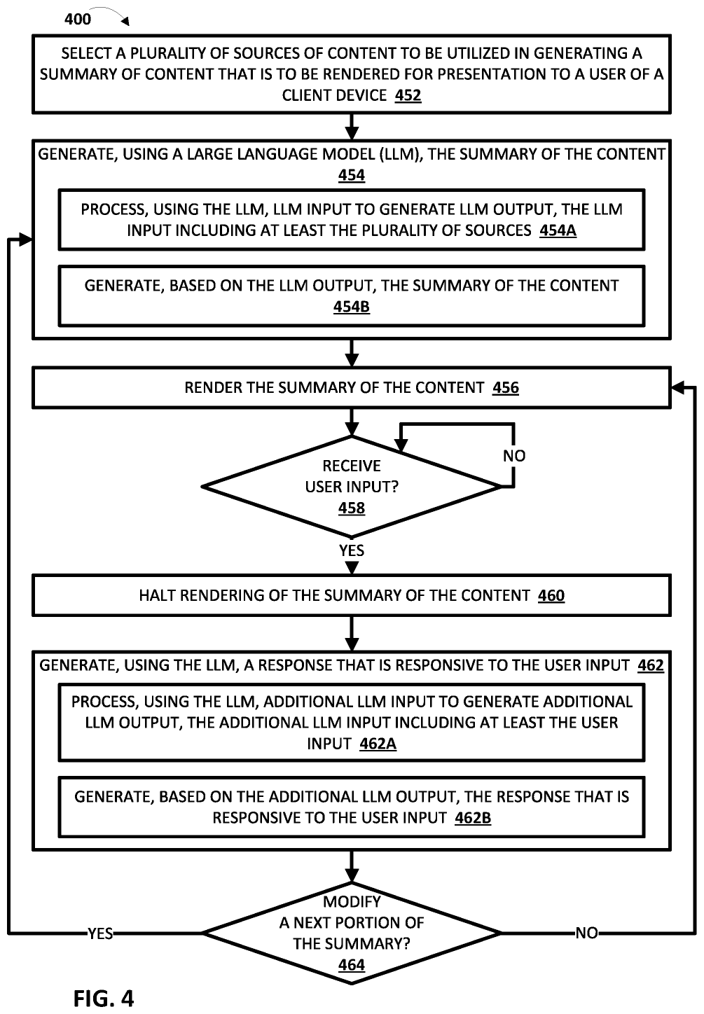

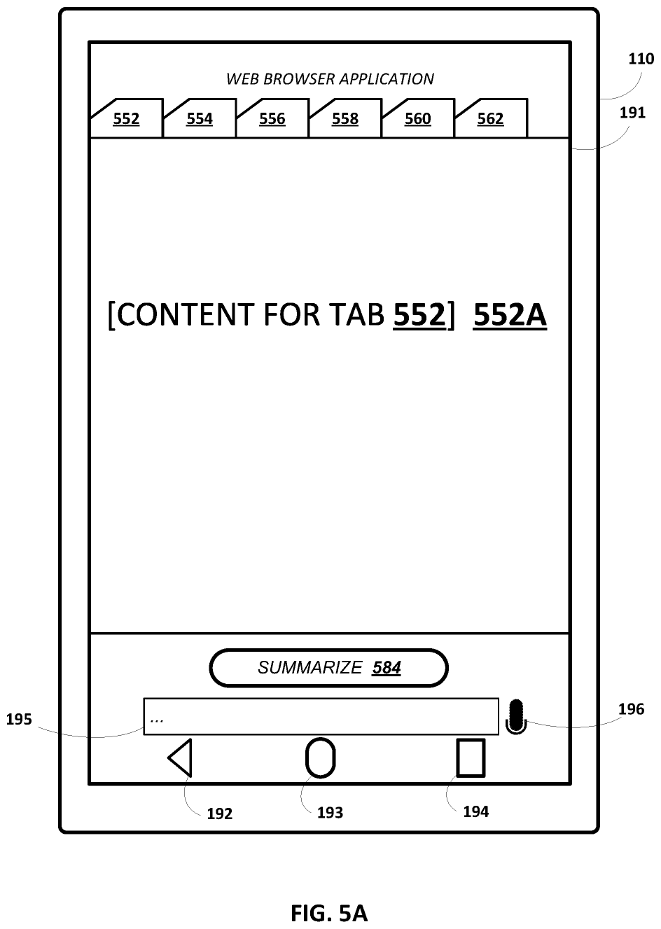

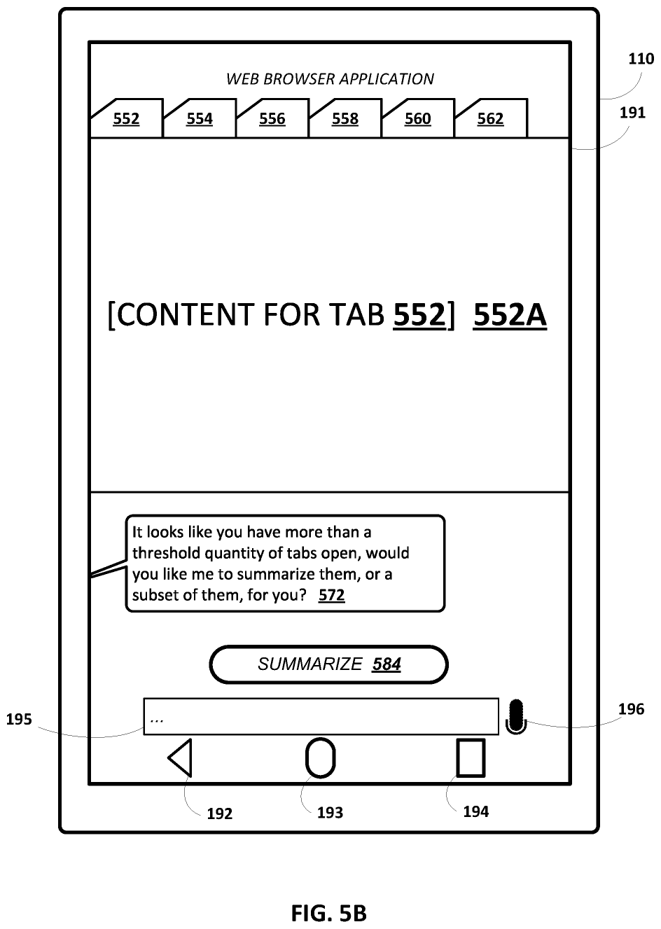

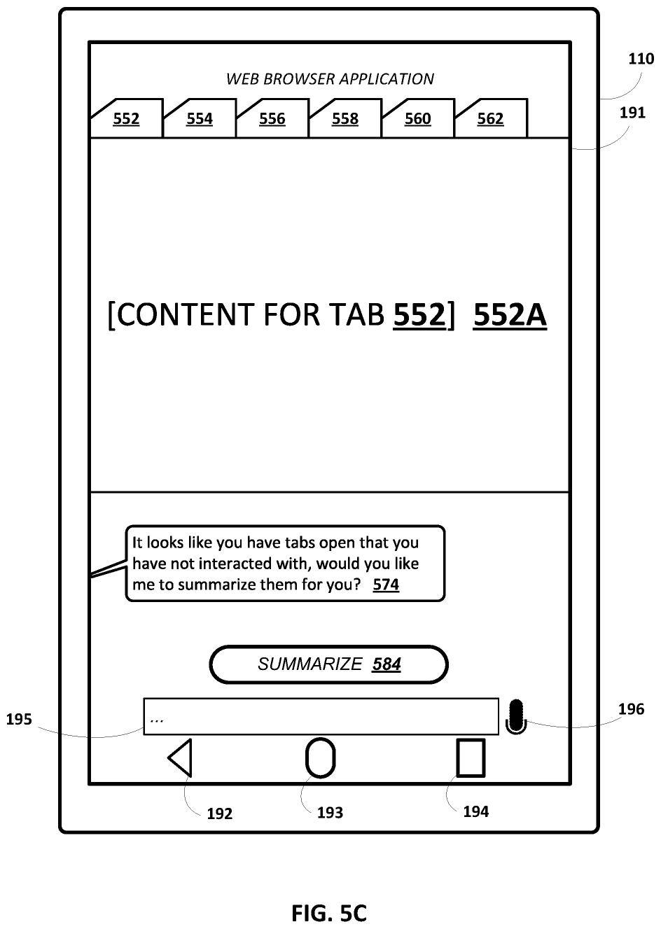

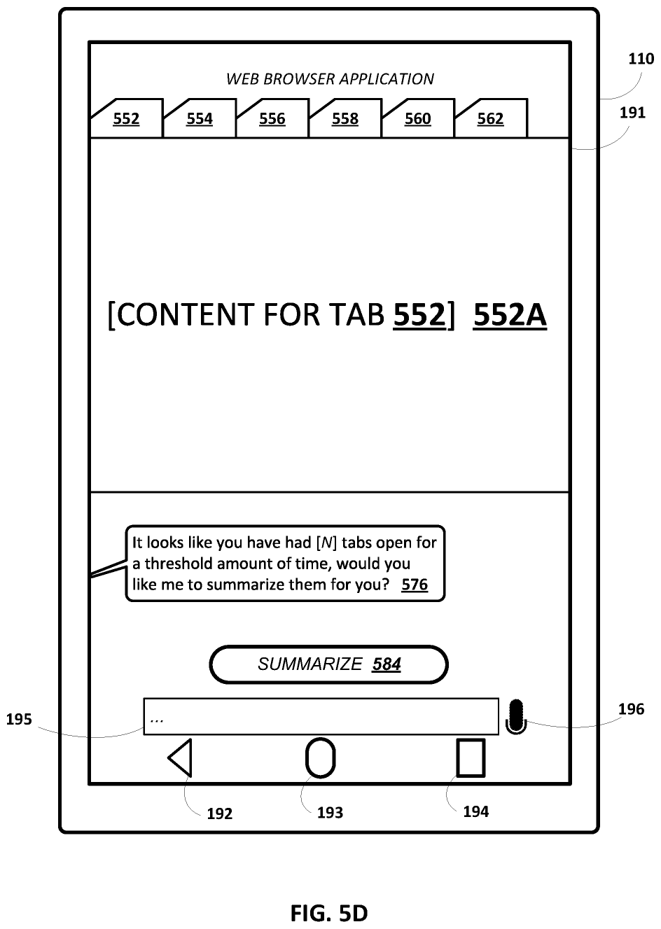

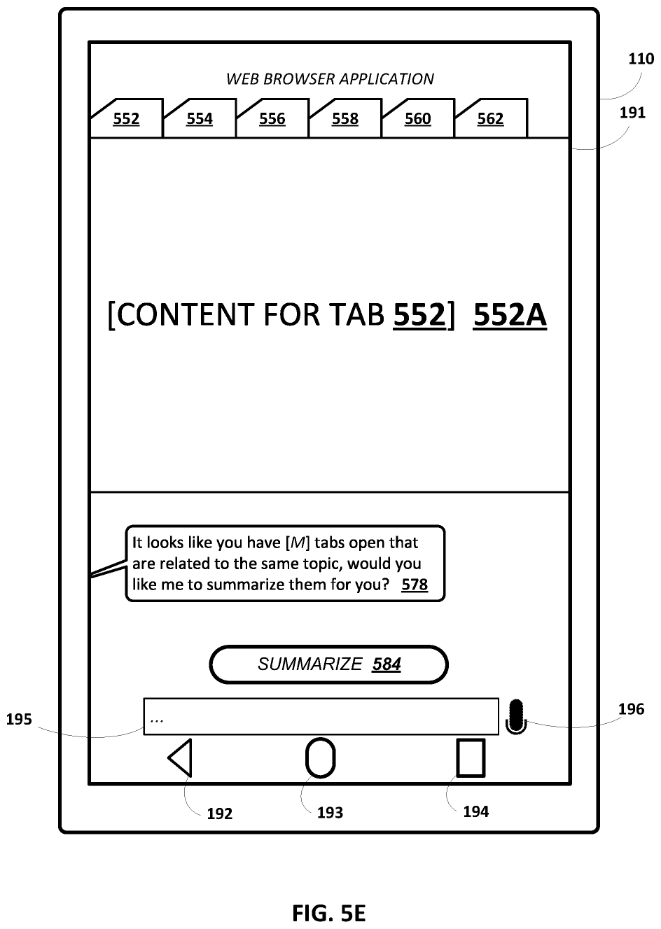

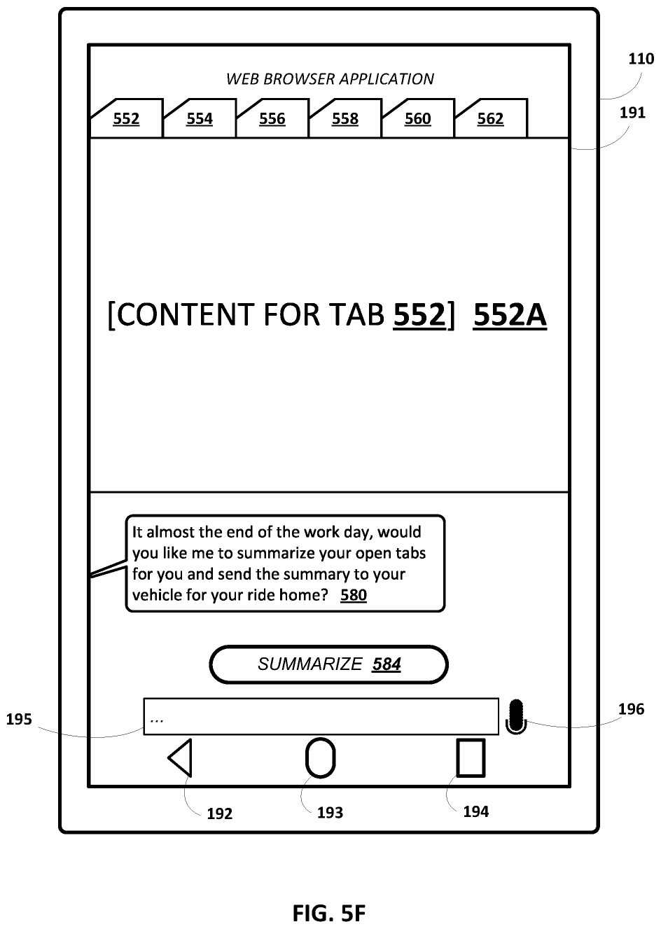

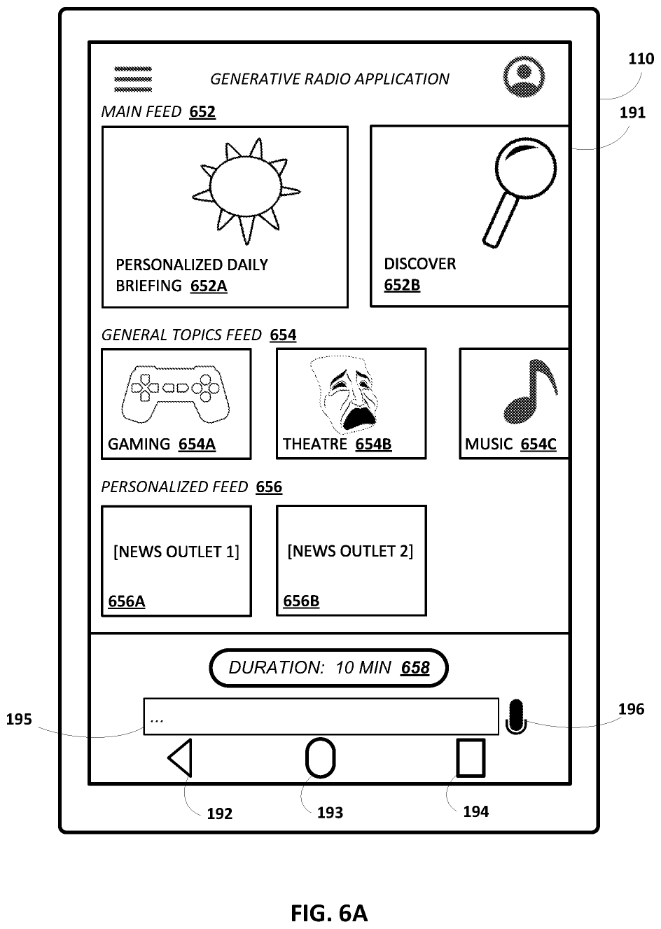

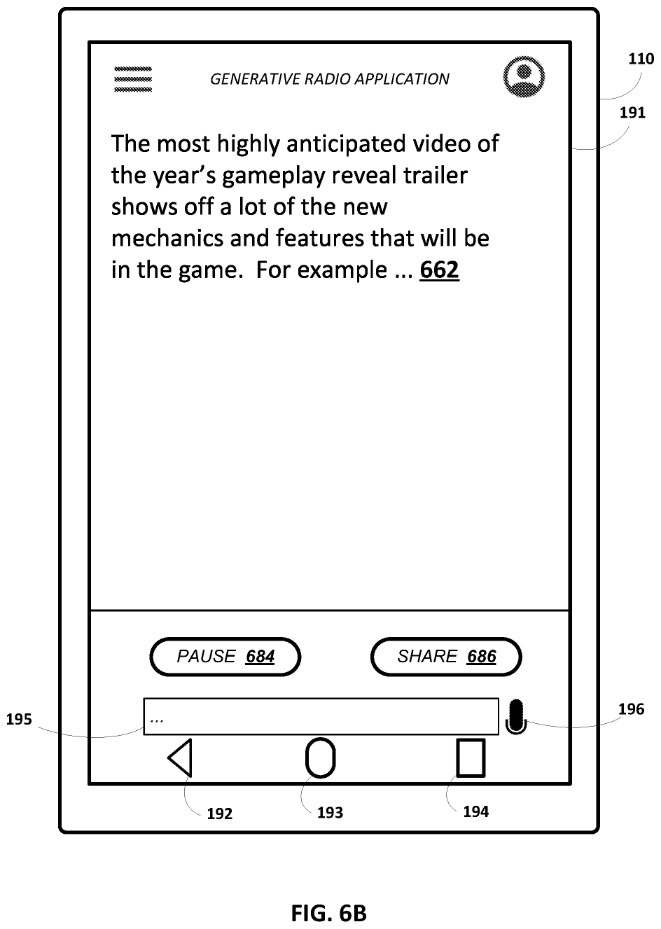

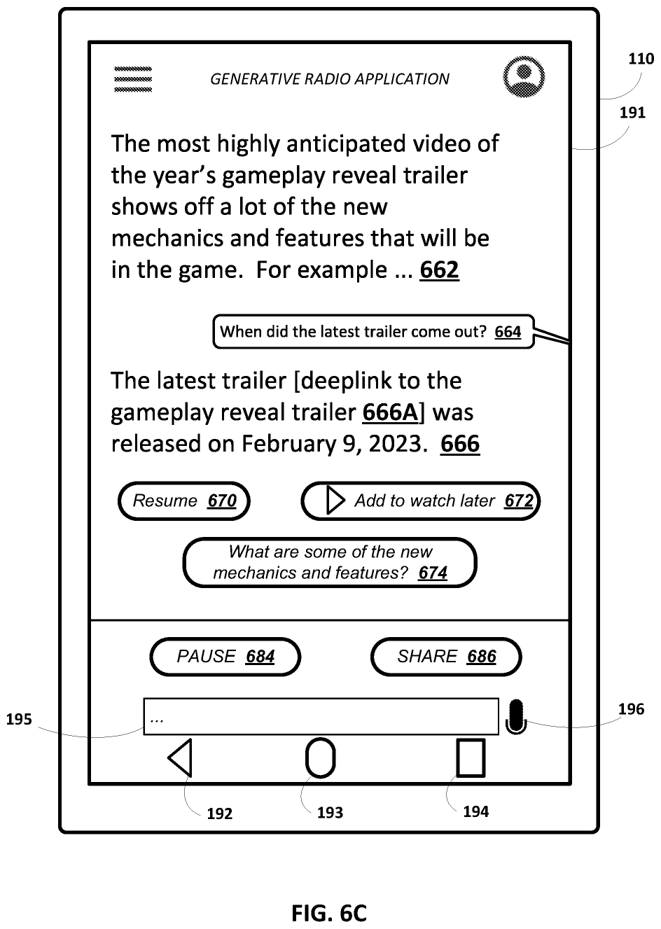

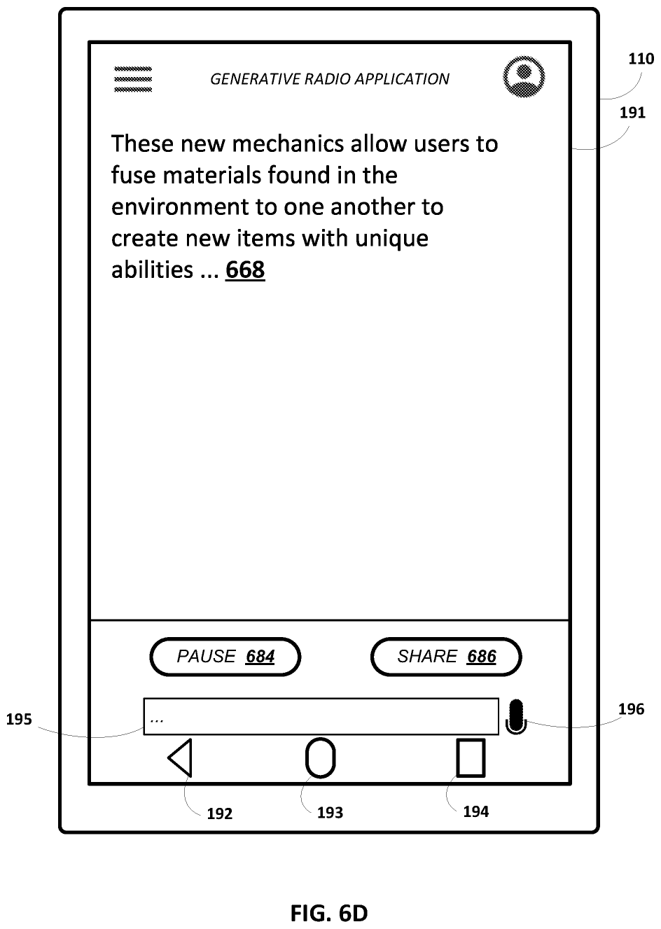

As described in more detail herein (e.g., with respect to FIGS. 2, 3, 4, 5A-5F, and 6A-6D), the generative content system 120 can be utilized to generate a summary of content to be rendered for presentation to a user of the client device 110. In some implementations, the summary of the content can be proactively generated and rendered for presentation to the user of the client device (e.g., as described with respect to FIGS. 2 and 5A-5F). In additional or alternative implementations, the summary of the content can be reactively generated and rendered for presentation to the user of the client device (e.g., as described with respect to FIGS. 3 and 6A-6B). In various implementations, and while the summary of the content is being rendered, the user of the client device 110 can interrupt the rendering of the summary of the content. In these implementations, the generative content system 120 can handle the interruption, and then resume rendering of the summary of the content (e.g., as described with respect to FIGS. 4 and 6C-6D). Notably, a plurality of sources of the content may include two or more open tabs in a web browser of the user, two or more news articles from news outlet(s) (e.g., that are of interest to the user, subscribed to by the user, etc.), and/or other source(s). Accordingly, not only is the summary of the content personalized to the user of the client device 110, but techniques described herein also enable the user of the client device 110 to interact with the generative content system 120 while the summary of the content is being rendered.

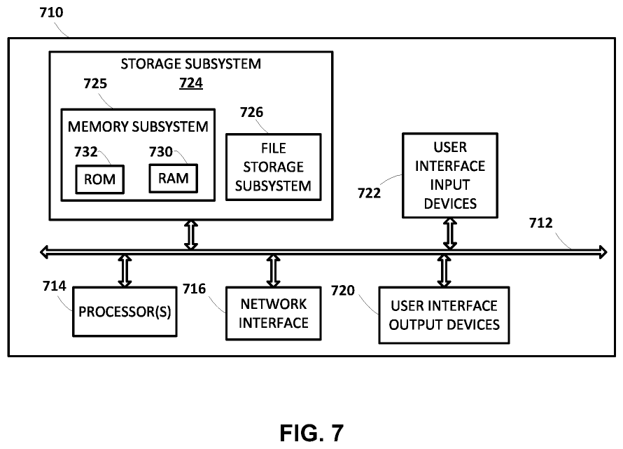

Turning now to FIG. 2, a flowchart illustrating an example method 200 of proactively generating and rendering a summary of content is depicted. For convenience, the operations of the method 200 are described with reference to a system that performs the operations. This system of the method 200 includes one or more processors, memory, and/or other component(s) of computing device(s) (e.g., client device 110 of FIG. 1, generative content system 120 of FIG. 1, computing device 710 of FIG. 7, one or more servers, and/or other computing devices). Moreover, while operations of the method 200 are shown in a particular order, this is not meant to be limiting. One or more operations may be reordered, omitted, and/or added.

At block 252, the system determines whether to generate a summary of content that is to be rendered for presentation to a user via a client device of the user. The system can determine whether to generate the summary of the content based on determining whether one or more triggering criteria are satisfied to generate the summary of the content. For example, the system can cause the triggering criteria engine 130 to monitor for satisfaction of one or more of the triggering criteria. Notably, one or more of the triggering criteria may vary based on a type of source(s) of the content.

For instance, and assuming that the type of the source(s) of the content correspond to two or more open tabs of a web browser, one or more of the triggering criteria (e.g., stored in the triggering criteria database 130A) can include: a quantity criterion that indicates a quantity of the two or more open tabs of the web browser satisfies a quantity threshold (e.g., as described with respect to FIG. 5B), an interaction criterion that indicates interaction (or an extent of interaction) with the two or more open tabs of the web browser satisfies an interaction threshold (e.g., as described with respect to FIG. 5C), a temporal criterion that indicates a time the two or more open tabs in the web browser have been open satisfies a temporal threshold (e.g., as described with respect to FIG. 5D), a topic criterion that indicates a given topic of the two or more open tabs of the web browser satisfies a similarity threshold (e.g., as described with respect to FIG. 5E), a situational criterion associated with a time of day or predicted activity of the user indicates a likelihood that the user will consume the two or more open tabs in the web browser satisfies a likelihood threshold (e.g., as described with respect to FIG. 5F), and/or other triggering criteria.

Also, for instance, and assuming that the type of the source(s) of the content correspond to two or more new articles of a news outlet(s), one or more of the triggering criteria (e.g., stored in the triggering criteria database 130A) can include: a quantity criterion that indicates a quantity of the two or more new articles from the one or more news outlets satisfies a quantity threshold, a topic criterion that indicates a given topic of the two or more new articles from the one or more news outlets satisfies a similarity threshold, a situational criterion associated with a time of day or predicted activity of the user indicates a likelihood that the user will consume the two or more new articles from the one or more news outlets satisfies a likelihood threshold, and/or other triggering criteria.

If, at an iteration of block 252, the system determines that one or more of the triggering criteria are not satisfied, then the system continues monitoring for satisfaction of one or more of the triggering criteria at block 252. If, at an iteration of block 252, the system determines that one or more of the triggering criteria are satisfied, then the system proceeds to block 254.

At block 254, the system selects, based on which of one or more of the triggering criteria that are satisfied, a plurality of sources to be utilized in generating the summary of the content. For example, the system can cause the source selection engine 140 to select the plurality of sources that are associated with one or more of the triggering criteria that are satisfied. Additional description of selecting the plurality of sources to be utilized in generating the summary of the content and based on which of one or more of the triggering criteria that are satisfied is provided herein with respect to FIGS. 5A-5F.

Notably, in various implementations of performing an iteration of the method 200 of FIG. 2, the system may determine that two or more of the triggering criteria are satisfied at a given instance of time. In some versions of these implementations, the system can perform multiple iterations of the method in a parallel manner (e.g., for each of the two or more triggering criteria that are satisfied) or a serial manner. Put another way, the system can generate multiple summaries of content for each of the two or more of the triggering criteria that are satisfied. Further, in generating the multiple summaries of the content, the system can utilize a deduping technique to ensure that there are not overlapping sources of the content between the multiple summaries of the content. In additional or alternative versions of these implementations, the system can merge the sources for each of the multiple summaries of the content for each of the two or more of the triggering criteria that are satisfied such that the system only generates a single summary of content.

At block 256, the system determines, based on one or more summarization criteria, a degree of summarization for the content. For example, the system can cause the summarization criteria engine 150 to determine the one or more summarization criteria. The one or more summarization criteria can include, for example, a temporal duration over which the summary of the content is to be rendered for presentation to the user (e.g., utilizing a prompt of “summarize content included each of these sources for audible rendering over X minutes”, where X is a positive integer), or a textual length of which the summary of the content is to be rendered for presentation to the user (e.g., utilizing a prompt of “summarize content included in each of these sources in Ywords (or sentences or paragraphs)”, where Y is a positive integer). However, in various implementations, it should be noted that the operations of block 256 may be omitted.

Notably, the degree of summarization may be determined dynamically based on the one or more summarization criteria. For example, the system can cause the summarization criteria engine 150 to determine the one or more summarization criteria based on a quantity of the sources of the content included in the plurality of sources of the content, availability content determined based on a calendar of the user, navigation content determined based on a predicted navigation duration of the user, a level of expertise of the user of the given client device with respect to a topic of the summary of the content (e.g., which can be explicitly provided by the user of the client device or inferred based on data stored in the user profile database 110B), and/or based on other factors. For instance, assume that the system determines to generate and render a summary of content based on one or more of the triggering criteria being satisfied. Further assume that the calendar of the user indicates that the user is available for the next 10 minutes before a work meeting, and that there are 10 sources to be summarized. In this instance, the degree of summarization may indicate that each source should be summarized for a duration of 1 minute. In contrast, assume that the calendar of the user indicates that the user is available for the next 10 minutes before a work meeting, but that there are 20 sources to be summarized. In this instance, the degree of summarization may indicate that each source should be summarized for a duration of 30 seconds. Accordingly, the degree of summarization can influence how robust the summary is for each of the sources, which can be dynamically determined based on a quantity of the source(s) and other information that is available to the system (e.g., the calendar of the user in the above instance).

At block 258, the system generates, using a large language model (LLM), the summary of the content. For example, at sub-block 258A, the system can process, using the LLM, LLM input to generate LLM output, the LLM input including at least the plurality of sources and an indication of the degree of summarization. For instance, the system can cause the LLM input engine 161 to formulate the LLM input as a structured input to be processed using the LLM. As noted above, the LLM input can include at least the plurality of sources (or an indication of content associated with each of the plurality of sources) and the indication of the degree of summarization. Accordingly, in formulating the LLM input, the LLM input engine 161 can generate, for instance, a prompt of “summarize content included each of these sources for audible rendering overX minutes” that is included in LLM input or a prompt of “summarize content included each of these sources for an expert in the field”, where X is a positive integer that can be dynamically determined as described above. In implementations where the operations of block 256 are omitted, the LLM input may not include the indication of the degree of summarization.

Further, the system can cause the LLM processing engine 162 to process, using the LLM, the LLM output to generate the LLM output. The LLM that is utilized can include, for example, any LLM that is stored in the LLM(s) database 160A, such as PaLM, BARD, BERT, LaMDA, Meena, GPT, and/or any other LLM, such as any other LLM that is encoder-only based, decoder-only based, sequence-to-sequence based and that optionally includes an attention mechanism or other memory. Notably, the LLM can include billions of weights and/or parameters that are learned through training the LLM on enormous amounts of diverse data. This enables the LLM to generate the LLM output as a probability distribution over a sequence of tokens (e.g., words, word units, or other representations of textual content) and based on processing the LLM input.

Moreover, at sub-block 258B, the system can generate, based on the LLM output, the summary of the content. Put another way, the system can cause the LLM output engine 163 to determine the summary of the content from among the sequence of tokens and based on the probability distribution over the sequence of tokens.

At block 260, the system renders the summary of the content. For example, at sub-block 260A, the system can cause the rendering engine 112 to visually render the summary of the content via a display of the client device of the user. For instance, the system can cause the rendering engine 112 to leverage data that includes the summary of the content to cause the summary content to be visually rendered for presentation to the user. Additionally, or alternatively, at sub-block 260B, the system can cause the rendering engine 112 to audibly render the summary of the content via speaker(s) of the client device of the user. For instance, the system can cause the rendering engine 112 to leverage data that includes synthesized speech audio data corresponding to the summary of the content to cause the summary content to be audibly rendered for presentation to the user. The system can return to block 252 to perform another iteration of the method 200 of FIG. 2 based on determining one or more triggering criteria are satisfied.

Although the method 200 of FIG. 2 is described with respect to proactively generating and rendering the summary of the content, it should be understood that is only one technique contemplated herein and is not meant to be limiting. For example, other techniques are described here for generating and rendering the summary of the content (e.g., as described with respect to FIG. 3). Further, although the method 200 of FIG. 2 is not described with respect to the user interrupting the rendering of the summary of the content, it should be understood that is for the sake of brevity and is not meant to be limiting. For example, other techniques are described here for handling interruptions during the rendering of the summary of the content (e.g., as described with respect to FIG. 4).

Turning now to FIG. 3, a flowchart illustrating an example method 300 of reactively generating and rendering a summary of content is depicted. For convenience, the operations of the method 300 are described with reference to a system that performs the operations. This system of the method 300 includes one or more processors, memory, and/or other component(s) of computing device(s) (e.g., client device 110 of FIG. 1, generative content system 120 of FIG. 1, computing device 710 of FIG. 7, one or more servers, and/or other computing devices). Moreover, while operations of the method 300 are shown in a particular order, this is not meant to be limiting. One or more operations may be reordered, omitted, and/or added.

At block 352, the system receives user input to generate a summary of content, the user input being received via a client device of a user. For example, the system can cause the user input engine 111 to detect the user input, and the user input engine 111 can provide the user input to the system. In some implementations, the user input can be a spoken utterance that is provided by the user of the client device. In these implementations, the user input engine 111 can process, using ASR model(s), audio data capturing the spoken utterance to generate ASR output (e.g., recognized text corresponding to the spoken utterance). In additional or alternative implementations, the user input can be touch input and/or typed input received via a software application that is accessible at the client device (e.g., as described with respect to FIG. 6A).

At block 354, the system selects, based on the user input, a plurality of sources to be utilized in generating the summary of the content. In some implementations, the user input can explicitly identify the plurality of sources to be utilized in generating the summary of the content. For example, the system can cause the source selection engine 140 to identify open tabs of a web browser that are specified by the user input (e.g., “summarize all of my open tabs that are related to topic Z” or the like). As another example, the system can cause the source selection engine 140 to identify news articles from a given news outlet that are specified by the user input (e.g., “summarize all of given news outlet's articles in the last three days that are related to topic Z” or the like). In additional or alternative implementations, the user input can inferentially identify the plurality of sources to be utilized in generating the summary of the content. For example, the system can cause the source selection engine 140 to identify two or more news articles from one or more news outlets that are related to a given topic based on a user selection of a selectable element via a software application (e.g., as described with respect to FIG. 6A).

At block 356, the system determines, based on one or more summarization criteria, a degree of summarization for the content. For example, the system can cause the summarization criteria engine 150 to determine the one or more summarization criteria. The one or more summarization criteria can include, for example, a temporal duration over which the summary of the content is to be rendered for presentation to the user (e.g., utilizing a prompt of “summarize content included each of these sources for audible rendering over X minutes”, where X is a positive integer), or a textual length of which the summary of the content is to be rendered for presentation to the user (e.g., utilizing a prompt of “summarize content included in each of these sources in Ywords (or sentences or paragraphs)”, where Y is a positive integer). In implementations of the method 300 of FIG. 3, the system can optionally determine the one or more summarization criteria based on the user input that is received at block 352 or additional user input (e.g., as described with respect to FIG. 6A). However, in various implementations, it should be noted that the operations of block 356 may be omitted.

Notably, the degree of summarization may be determined dynamically based on the one or more summarization criteria. For example, the system can cause the summarization criteria engine 150 to determine the one or more summarization criteria based on a quantity of the sources of the content included in the plurality of sources of the content and based on the user input that is received at block 352 or additional user input. For instance, assume that the system determines to generate and render a summary of content based on the user input that is received. Further assume that the user input or the additional user input is associated with a “gaming” topic that indicates the summary of the content should be audibly rendered over a duration of 30 minutes. In this instance, a plurality of sources related to “gaming news” can be selected (e.g., from source(s) database 140A and/or utilizing the external system(s) 190 to obtain the source(s)), and the degree of summarization may indicate that a total duration for audibly rendering the summary of the content should be 30 minutes. In contrast, assume that the user input or the additional user input is associated with a “gaming” topic that indicates the summary of the content should be audibly rendered over a duration of 10 minutes. In these instances, and assuming the same quantity of sources are selected, the degree of summarization for the former instance, as compared to the latter instance, will result in a more robust summary since the duration is longer in the former instance.

At block 358, the system generates, using a large language model (LLM), the summary of the content. For example, at sub-block 358A, the system can process, using the LLM, LLM input to generate LLM output, the LLM input including at least the plurality of sources and an indication of the degree of summarization. Further, at sub-block 358B, the system can generate, based on the LLM output, the summary of the content. Notably, the system can perform the operations of block 358 in the same or similar manner described above with respect to block 258 of the method 200 of FIG. 2 (and optionally omitting the indication of the degree of summarization).

At block 360, the system renders the summary of the content. For example, at sub-block 360A, the system can cause the rendering engine 112 to visually render the summary of the content via a display of the client device of the user. Additionally, or alternatively, at sub-block 360B, the system can cause the rendering engine 112 to audibly render the summary of the content via speaker(s) of the client device of the user. Notably, the system can perform the operations of block 360 in the same or similar manner described above with respect to block 260 of the method 200 of FIG. 2. The system can return to block 352 to perform another iteration of the method 300 of FIG. 3 based on additional user input that is received to generate an additional summary of additional content.

Although the method 300 of FIG. 3 is not described with respect to the user interrupting the rendering of the summary of the content, it should be understood that is for the sake of brevity and is not meant to be limiting. For example, other techniques are described here for handling interruptions during the rendering of the summary of the content (e.g., as described with respect to FIG. 4).

Turning now to FIG. 4, a flowchart illustrating an example method 400 of handling interruptions during rendering of a summary of content is depicted. For convenience, the operations of the method 400 are described with reference to a system that performs the operations. This system of the method 400 includes one or more processors, memory, and/or other component(s) of computing device(s) (e.g., client device 110 of FIG. 1, generative content system 120 of FIG. 1, computing device 710 of FIG. 7, one or more servers, and/or other computing devices). Moreover, while operations of the method 400 are shown in a particular order, this is not meant to be limiting. One or more operations may be reordered, omitted, and/or added.

At block 452, the system selects a plurality of sources of content to be utilized in generating a summary of content that is to be rendered for presentation to a user of a client device. In some implementations, the system can proactively determine to generate and render the summary of the content (e.g., as described with respect to the method 200 of FIG. 2). In these implementations, the system can select the plurality of sources of the content in the same or similar manner described with respect to block 254 of the method 200 of FIG. 2. In additional or alternative implementations, the system can reactively determine to generate and render the summary of the content (e.g., as described with respect to the method 300 of FIG. 3). In these implementations, the system can select the plurality of sources of the content in the same or similar manner described with respect to block 354 of the method 300 of FIG. 3.

At block 454, the system generates, using a large language model (LLM), the summary of the content. For example, at sub-block 454A, the system can process, using the LLM, LLM input to generate LLM output, the LLM input including at least the plurality of sources. Further, at sub-block 454B, the system can generate, based on the LLM output, the summary of the content. Notably, the system can perform the operations of block 454 in the same or similar manner described above with respect to block 258 of the method 200 of FIG. 2.

At block 456, the system renders the summary of the content. For example, the system can cause the rendering engine 112 to visually render the summary of the content via a display of the client device of the user. Additionally, or alternatively, the system can cause the rendering engine 112 to audibly render the summary of the content via speaker(s) of the client device of the user. Notably, the system can perform the operations of block 456 in the same or similar manner described above with respect to block 260 of the method 200 of FIG. 2.

At block 458, the system determines whether user input is received while the summary of the content is being rendered for presentation to the user via the client device. For example, the system can cause the user input engine 111 to detect the user input, and the user input engine 111 can provide the user input to the system. In some implementations, the user input can be a spoken utterance that is provided by the user of the client device. In these implementations, the user input engine 111 can process, using ASR model(s), audio data capturing the spoken utterance to generate ASR output (e.g., recognized text corresponding to the spoken utterance). In additional or alternative implementations, the user input can be touch input and/or typed input received via a software application that is accessible at the client device (e.g., as described with respect to FIG. 6A).

If, at an iteration of block 458, the system determines that no user input is received while the summary of the content is being rendered, then the system continues rendering of the summary of the content and monitoring for user input to be received. The system can continue monitoring for the user input throughout a duration of rendering of the summary of the content. If, at an iteration of block 458, the system determines that user input is received while the summary of the content is being rendered, then the system proceeds to block 460.

At block 460, the system halts rendering of the summary of the content. For example, the system can cause the halt engine 171 to halt the rendering of the summary of the content. In some implementations, the halt engine 171 may immediately halt rendering of the summary of the content in response to the user input being received. In other implementations, the halt engine 171 may continue rendering a current portion of the summary of the content in response to the user input being received and then halt rendering of the summary of the content in response to the current portion of the summary of the content being rendered. The current portion of the summary of the content can be, for example, a current word being rendered, a current sentence being rendered, a current paragraph being rendered, and/or other logical arrangements of the summary of the content being rendered. In some versions of these implementations, the system can render some indication (e.g., audibly or visually) that the user input was received to notify the user that the user input was, in fact, received. In various implementations, the halt engine 171 can bookmark a next portion of the summary of the content, that follows the current portion of the summary of the content, to be bookmarked. In these implementations, the halt engine 171 can further cause the next portion of the summary of the content, and optionally any remaining portions of the summary of the content (if any), to be stored in the content state database 170A.

At block 462, the system generates, using the LLM, a response that is responsive to the user input. In implementations where the halt engine 171 continues rendering the current portion of the summary of the content in response to the user input being received and then halts rendering of the summary of the content in response to the current portion of the summary of the content being rendered, the system can initiate generating the response that is responsive to the user input while the current portion of the summary of the content is being rendered. This parallelization of continuing to render the current portion of the summary of the content while initiating processing of the user input that is received reduces latency in the human-to-computer interaction.

For example, at sub-block 462A, the system can process, using the LLM, additional LLM input to generate additional LLM output, the additional LLM input including at least the user input. For instance, the system can cause the LLM input engine 161 to formulate the additional LLM input as a structured input to be processed using the LLM. As noted above, the additional LLM input can include at least the user input. However, it should be understood that the additional LLM input can include additional content. For example (e.g., and as described with respect to FIG. 6C), the additional LLM input can include search result(s) that are obtained by the LLM input and using the external system(s) 190. For instance, based on the user input, the LLM input engine 161 can formulate a query to be submitted to a search system to obtain search result document(s) and content of the search result document(s) can also be included in the additional LLM input. Accordingly, in formulating the additional LLM input, the LLM input engine 161 can generate, for instance, a prompt of “generate a response to [user input] and consider [search result document(s)] if any” that is included in additional LLM input.

Further, the system can cause the LLM processing engine 162 to process, using the LLM, the additional LLM output to generate the additional LLM output. As noted with respect to the method 200 of FIG. 2, the LLM that is utilized can include, for example, any LLM that is stored in the LLM(s) database 160A, such as PaLM, BARD, BERT, LaMDA, Meena, GPT, and/or any other LLM, such as any other LLM that is encoder-only based, decoder-only based, sequence-to-sequence based and that optionally includes an attention mechanism or other memory. Notably, the LLM can include billions of weights and/or parameters that are learned through training the LLM on enormous amounts of diverse data. This enables the LLM to generate the additional LLM output as an additional probability distribution over an additional sequence of tokens (e.g., words, word units, or other representations of textual content) and based on processing the additional LLM input.

Moreover, at sub-block 462B, the system can generate, based on the additional LLM output, the response that is responsive to the user input. Put another way, the system can cause the LLM output engine 163 to determine the response that is responsive to the user input from among the sequence of tokens and based on the additional probability distribution over the additional sequence of tokens.

At block 464, the system determines whether to modify a next portion of the summary of the content (or any other remaining portion of the summary of the content). The system can determine whether to modify the next portion of the summary of the content (or any other remaining portion of the summary of the content) based on, for example, the user input and/or the response that is responsive to the user input. For example, the system can cause the modification engine 172 to determine whether the user input and/or the response that is responsive to the user input includes corresponding content that is included in the next portion of the summary of the content (or any other remaining portion of the summary of the content). In doing so, the modification engine 172 can utilize one or more existing techniques to determine whether the user input and/or the response that is responsive to the user input includes corresponding content that is included in the next portion of the summary of the content (or any other remaining portion of the summary of the content). For instance, the modification engine 172 can compare a semantic embedding of the user input and/or the response that is responsive to the user input to a semantic embedding of the next portion of the summary of the content (or any other remaining portion of the summary of the content), can determine a Levenshtein distance between the user input and/or the response that is responsive to the user input and the next portion of the summary of the content (or any other remaining portion of the summary of the content), and/or can utilize other techniques to compare the user input and/or the response that is responsive to the user input with next portion of the summary of the content (or any other remaining portion of the summary of the content). This enables the system to mitigate and/or eliminate instances of the next portion of the summary of the content (or any other remaining portion of the summary of the content) being subsequently rendered when it includes the same content as the user input and/or the response that is responsive to the user input.

If, at an iteration of block 464, the system determines not to modify the next portion of the summary of the content (or any other remaining portion of the summary of the content), the system returns to block 456 to continue rendering the summary of the content. For example, the system can cause the resumption engine 173 to identify the next portion of the summary of the content that was bookmarked (and any other remaining portion of the summary of the content) from the content state database 170A and continue rendering the summary of the content starting with the next portion of the summary of the content at an additional iteration of the operations of block 456. In various implementations, and even though the system may determine to not modify the next portion of the summary of the content (e.g., by using the LLM and/or by omitting the next portion of the summary of the content (or by omitting a remaining portion of the summary of the content)), the system can utilize a transition phrase and/or alternative sentence structure for the next portion of the summary of the content to ensure that the rendering of the next portion of the summary of the content flows naturally from the rendering of the response that is responsive to the user input.

Further, and in continuing rendering of the summary of the content starting with the next portion of the summary of the content, the system may proceed to an additional iteration of the operations of block 458 to determine whether additional user input is received and continue with the method 300 of FIG. 3. For instance, assume the summary of the content is about “gaming news” and the user input requests a weather forecast. In this instance, it is unlikely that the user input and/or a response that is responsive to the user input (e.g., the weather forecast) will correspond to content that is included in the next portion of the summary of the content for “gaming news” (or any other remaining portion of the summary of the content for “gaming news”). Accordingly, the system can respond to the user, and then resume providing the summary of the content.

If, at an iteration of block 464, the system determines to modify the next portion of the summary of the content (or any other remaining portion of the summary of the content), the system returns to block 454. For example, the system can perform the same or similar operations of block 454 as described above, but the LLM input that is processed at the additional iteration of block 454 can also include (e.g., in addition to the plurality of sources of the content) an indication that the any re-generated portions of the summary of the content should be generated without including any content of the user input and/or of the response that is responsive to the user input, and without including any content that has already been rendered.

In additional or alternative implementations, and rather than re-generating portions of the summary of the content, the system can omit the next portion of the summary of the content (or any other remaining portion of the summary of the content). In these implementations, the system can cause the modification engine 172 to modify the next portion of the summary of the content (or any other remaining portion of the summary of the content) in the content state database 170A prior to the resumption engine 172 causing the rendering of the summary of the content to be resumed. Further, in some versions of these implementations, the system may only omit the next portion of the summary of the content (or any other remaining portion of the summary of the content) in response to determining the user input and/or the response that is responsive to the user input has a threshold similarity to the summary of the content (or any other remaining portion of the summary of the content). However, it should be noted that omitting the next portion of the summary of the content (or any other remaining portion of the summary of the content) may result in the next portion of the summary of the content (or any other remaining portion of the summary of the content) not being semantically coherent. Nonetheless, by omitting the next portion of the summary of the content (or any other remaining portion of the summary of the content) and rather than re-generating portions of the summary of the content, computational resources can be conserved by the system. The system can continue handling interruptions until the rendering of the summary of the content is complete.

Turning now to FIGS. 5A, 5B, 5C, 5D, 5E, and 5F, various non-limiting examples of proactively generating and rendering a summary of content are depicted. A client device 110 (e.g., the client device 110 from FIG. 1) may include various user interface components including, for example, microphone(s) to generate audio data based on spoken utterances and/or other audible input, speaker(s) to audibly render synthesized speech and/or other audible output, and/or a display 191 to visually render visual output. Further, the display 191 of the client device 110 can include various system interface elements 192, 193, and 194 (e.g., hardware and/or software interface elements) that may be interacted with by a user of the client device 110 to cause the client device 110 to perform one or more actions. The display 191 of the client device 110 enables the user to interact with content rendered on the display 191 by touch input (e.g., by directing user input to the display 191 or portions thereof (e.g., to a text entry box 195, to a keyboard (not depicted), or to other portions of the display 191)) and/or by spoken input (e.g., by selecting microphone interface element 196—or just by speaking without necessarily selecting the microphone interface element 196 (i.e., an automated assistant may monitor for one or more terms or phrases, gesture(s) gaze(s), mouth movement(s), lip movement(s), and/or other conditions to activate spoken input) at the client device 110). Although the client device 110 depicted in FIGS. 5A, 5B, 5C, 5D, 5E, and 5F is a mobile phone, it should be understood that is for the sake of example and is not meant to be limiting. For example, the client device 110 may be a standalone speaker with a display, a standalone speaker without a display, a home automation device, an in-vehicle system, a laptop, a desktop computer, and/or any other device capable of executing an automated assistant to engage in a human-to-computer dialog session with the user of the client device 110.

Referring specifically to FIG. 5A, assume that a user of the client device 110 is interacting with a web browser application and has a plurality of tabs 552, 554, 556, 558, 560, and 562 open on the web browser application. Further assume that the user is viewing content of tab 552 as indicated by 552A. In some implementations, the display 191 of the client device 110 may include a selectable element 584 that, when selected, causes a summary of content to be generated. In some versions of those implementations, and in response to receiving a selection of the selectable element 584 (e.g., a voice or spoken selection, a touch selection, etc.), the content of tab 552 may be summarized. In additional or alternative implementations, and in response to receiving the selection of the selectable element 584, a user interface that enables the user to select which of the plurality of tabs 552, 554, 556, 558, 560, and 562 should be summarized. Accordingly, techniques described herein enable the user to cause content (e.g., the content of tab 552 and/or any of the other tabs 554, 556, 558, 560, and 562 to be quickly and efficiently summarized). However, it should be understood that in various implementations the selectable element 584 may be omitted and only provided in response to one or more triggering conditions (e.g., described with respect to the method 200 of FIG. 2) being satisfied.

For example, and referring specifically to FIG. 5B, assume that the one or more triggering criteria include a quantity criterion that indicates a quantity of the two or more open tabs of the web browser satisfies a quantity threshold. In this example, further assume that the quantity threshold is 5 open tabs. In response to determining that the user has more than 5 open tabs (e.g., there are 6 open tabs in the example of FIG. 5B), the client device 110 can cause a prompt 572 of “It looks like you have more than a threshold quantity of tabs open, would you like me to summarize them, or a subset of them, for you?” to be generated and rendered at the display 191 of the client device 110, and optionally along with the selectable element 584. Accordingly, in this example, and in response to receiving the selection of the selectable element 584, the content of the plurality of tabs 552, 554, 556, 558, 560, and 562 (or a subset thereof specified by the user) can be selected as corresponding to the sources, utilized in generating a summary of content, and the summary of the content rendered for presentation to the user via the client device 110 or an additional client device of the user. Notably, the quantity threshold may vary from device-to-device and based on various hardware limitations of the client device 110, such as a display size of the client device 110. In the example of FIG. 5B, the client device 110 is a mobile phone, which generally has a smaller display size as compared to a laptop or monitor(s) coupled with a laptop. Thus, the quantity threshold for a mobile phone (e.g., 5 open tabs in the example of FIG. 5B) may be smaller compared to a quantity threshold for a laptop (e.g., 10 open tabs, 15 open tabs, or the like).

As another example, and referring specifically to FIG. 5C, assume that the one or more triggering criteria include an interaction criterion that indicates interaction (or an extent of interaction) with the two or more open tabs of the web browser satisfies an interaction threshold. In this example, further assume that the quantity threshold is 3 open tabs that have not been interacted with by the user (e.g., the user opened the 3 tabs, but has not viewed them) or that have been interacted with less than a threshold extent (e.g., the user has scrolled less than a threshold amount of the content, the user has viewed for less than a threshold duration of time, etc.). In response to determining that the user has more than 3 open tabs that satisfy the interaction threshold, the client device 110 can cause a prompt 574 of “It looks like you have open tabs that you have not interacted with, would you like me to summarize them for you?” to be generated and rendered at the display 191 of the client device 110, and optionally along with the selectable element 584. Accordingly, in this example, and in response to receiving the selection of the selectable element 584, the content of the 3 open tabs with which the user has not interacted with, or has interacted with less than a threshold extent, can be selected as corresponding to the sources of content, utilized in generating a summary of content, and the summary of the content rendered for presentation to the user via the client device 110 or an additional client device of the user. Notably, the interaction threshold may vary from device-to-device and based on various limitations of the client device 110, such as a display size of the client device 110. In the example of FIG. 5C, the client device 110 is a mobile phone, which generally has a smaller display size as compared to a laptop or monitor(s) coupled with a laptop. Thus, the interaction threshold for a mobile phone (e.g., how much the user has scrolled in the example of FIG. 5C) may be greater compared to an interaction threshold for a laptop since the user should be able to view more content of each tab at a given point in time on the laptop as compared to the mobile phone.

As another example, and referring specifically to FIG. 5D, assume that the one or more triggering criteria include a temporal criterion that indicates a time the two or more open tabs in the web browser have been open satisfies a temporal threshold. In this example, further assume that the temporal threshold for the two or more of the tabs being open is 48 hours. In response to determining that the user has had two or more tabs open for more than 48 hours, the client device 110 can cause a prompt 576 of “It looks like you have had [N] tabs open for a threshold amount of time, would you like me to summarize them for you?” (e.g., where N is an integer equal to two or greater than two, and where the threshold amount of time is 48 hours in this example as noted above) to be generated and rendered at the display 191 of the client device 110, and optionally along with the selectable element 584. Accordingly, in this example, and in response to receiving the selection of the selectable element 584, the content of the N open tabs with which the user has had open at the client device 110 for 48 hours can be selected as corresponding to the sources of content, utilized in generating a summary of content, and the summary of the content rendered for presentation to the user via the client device 110 or an additional client device of the user. Notably, the temporal threshold may vary from device-to-device based on how often a user interacts with a client device. In the example of FIG. 5D, the client device 110 is a mobile phone, which generally is carried by a user (e.g., while the user is at home, while the user is at work, etc.). Thus, the temporal threshold for a mobile phone (e.g., since the mobile phone is generally on the user's person) may be greater compared to temporal threshold for a laptop since the user may utilize the laptop for a more limited time of day (e.g., while the user is at work).

As another example, and referring specifically to FIG. 5E, assume that the one or more triggering criteria include a topic criterion that indicates a given topic of the two or more open tabs of the web browser satisfies a similarity threshold. In this example, further assume that the similarity threshold for the two or more of the tabs is that they relate to the given topic (e.g., “technology”, “gaming”, “theatre”, or the like). In determining that the two or more of the tabs relate to the given topic, various existing techniques may be utilized. For instance, the two or more of the tabs may be determined to relate to the given topic based on utilization of a knowledge graph (e.g., “artificial intelligence” being a topic and/or keyword in one tab, and other topics and/or keywords relating to “large language models”, “neural networks”, “machine learning”, or the like in other tabs, and those topics and/or keywords being related in the knowledge graph), based on utilization of embeddings (e.g., embeddings for content in the open tabs being less than a threshold distance in embedding space and determined using cosine distance, Euclidean distance, or the like), based on a topic or semantic classifier processing content of the open tabs and the output of the topic or semantic classifier indicating that two or more of the open tabs are related to the given topic, and/or based on other existing techniques. Further, and in response to determining that the two or more of the tabs relate to the given topic, the client device 110 can cause a prompt 578 of “It looks like you have [M] tabs open that are related to the same topic, would you like me to summarize them for you?” (e.g., where M is an integer equal to two or greater than two) to be generated and rendered at the display 191 of the client device 110, and optionally along with the selectable element 584. Accordingly, in this example, and in response to receiving the selection of the selectable element 584, the content of the M open tabs that are open at the client device 110 and that are related to the same topic can be selected as corresponding to the sources of content, utilized in generating a summary of content, and the summary of the content rendered for presentation to the user via the client device 110 or an additional client device of the user. Notably, in the example of FIG. 5E, the client device 110 is a mobile phone, which the user may only be able to view a single tab at a time due to various hardware constraints of the client device 110, such as a reduced size of the display 191 as compared to other client devices (e.g., a laptop or a desktop where the user has more freedom to open other windows and view multiple tabs at a given instance of time). Thus, these techniques may be particularly advantageous in implementations where the client device 110 is a mobile device.

As another example, and referring specifically to FIG. 5F, assume that the one or more triggering criteria include a situational criterion associated with a time of day or predicted activity of the user indicates a likelihood that the user will consume the two or more open tabs in the web browser satisfies a likelihood threshold. In this example, further assume that the likelihood threshold for the time of day or the predicted activity of the user indicates that the user is about to leave work (e.g., based on a time being 4:55 PM when the user typically leaves work at 5:00 PM) and commute home, the client device 110 can cause a prompt 580 of “It is almost the end of the work day, would you like me to summarize your open tabs for you and send the summary to your vehicle for the ride home?” to be generated and rendered at the display 191 of the client device 110, and optionally along with the selectable element 584. Accordingly, in this example, and in response to receiving the selection of the selectable element 584, the content of the open tabs at the client device 110 can be selected as corresponding to the sources of content, utilized in generating a summary of content, and the summary of the content rendered for presentation to the user via a vehicle client device of the user.

Although the examples of FIGS. 5A-5F are not described with respect to determining a degree of summarization, it should be understood that is for the sake of example and is not meant to be limiting. For instance, in the examples of FIG. 5A-5E, the degree of summarization may be based on a quantity of the sources of the content included in the plurality of sources of the content and/or availability content determined based on a calendar of the user. In these instances, the availability content (e.g., determined based on the user's personal calendar, work calendar, or otherwise) may indicate that a user is only available to consume the summary of the content over a certain duration of time (e.g., 5 minutes, 10 minutes, or the like). Accordingly, how robust the summary of the content is (e.g., overall or for each of the sources), may be dependent upon how many sources there are and the certain duration of time. Also, for instance, in the example of FIG. 5F, the degree of summarization may be based on a quantity of the sources of the content included in the plurality of sources of the content and/or navigation content determined based on a predicted navigation duration of the user. In these instances, the navigation content (e.g., determined based on how long it will take the user to commute home) may also indicate that a user is only available to consume the summary of the content over a certain duration of time (e.g., 15 minutes, 20 minutes, or the like). Accordingly, how robust the summary of the content is (e.g., overall or for each of the sources), may be dependent upon how many sources there are and the certain duration of time. Nonetheless, it should be noted that in various implementations, the degree of summarization may be omitted, and the user can pause and/or resume consuming the summary of the content at their convenience.

Although the examples of FIGS. 5A-5F are described with respect to certain thresholds for the one or more triggering criteria, it should be understood that is for the sake of illustrating techniques contemplated herein and is not meant to be limiting. Rather it should be understood that the one or more triggering criteria and the summary of the content can be personalized on a user-by-user basis, and based on how the user interacts with the client device 110. Further, in various implementations, two or more of the triggering criteria may be satisfied. In these implementations, separate summaries of content may be generated, or a single summary of content may be generated. Moreover, in various implementations, the user may be able to define their own triggering criteria for when techniques herein determine to generate and render a summary of content.

Although the examples of FIGS. 5A-5F are described with respect to the sources of the content being open tabs in a single web browser application, it should be understood that is for the sake of example and is not meant to be limiting. For instance, it should be understood that open tabs across multiple open windows of a single web browser (e.g., multiple instances of the single web browser being open) or across multiple open windows of multiple web browsers (e.g., first-party web browsers and/or third-party web browsers) can be utilized as the sources of content in generating the summary of the content.

Although the examples of FIGS. 5A-5F are described with respect to the sources of the content being open tabs in a web browser application, it should be understood that is for the sake of example and is not meant to be limiting. For instance, in additional or alternative implementations, the sources of the content include two or more news articles from news outlet(s). In these implementations, one or more of the triggering criteria can include: a quantity criterion that indicates a quantity of the two or more new articles from the one or more news outlets satisfies a quantity threshold, a topic criterion that indicates a given topic of the two or more new articles from the one or more news outlets satisfies a similarity threshold, a situational criterion associated with a time of day or predicted activity of the user indicates a likelihood that the user will consume the two or more new articles from the one or more news outlets satisfies a likelihood threshold, and/or other triggering criteria. However, it should be noted that similar techniques described with respect to FIGS. 5C, 5E, and 5F may be utilized in determining to generate and render the summary of the content.

Turning now to FIGS. 6A, 6B, 6C, and 6D, various non-limiting examples of reactively generating and rendering a summary of content and handling interruptions during rendering of the summary of the content are depicted. A client device 110 (e.g., the client device 110 from FIG. 1) may be the same or similar to that described with respect to FIGS. 5A, 5B, 5C, 5D, 5E, and 5F. Referring specifically to FIG. 6A, assume that a user of the client device 110 is interacting with a generative radio application. The generative radio application can include a plurality of different feeds, such as a main feed 652, a general topics feed 654, and a personalized feed 656. Each of these different feeds of the generative radio application can include a plurality of different generative radio stations. For example, the main feed 652 can include a personalized daily briefing station 652A, a discover station 652B, and/or other stations; the general topics feed 654 can include a gaming station 654A, a theatre station 654B, a music station 654C, and/or other stations; and the personalized feed 656 can include a [NEWS OUTLET 1] station 656A, a [NEWS OUTLET 2] station 656B, and/or other stations.

With respect to the main feed 652, the personalized daily briefing station 652A can be generated based on, for example, user profile data (e.g., stored in the user profile database 652A), and can include weather content at a location of a user, calendar content for a day for the user, traffic content for a daily commute of the user, news of interest for the day for the user, and/or other content. Further, the discover station 652B can be generated based on, for example, content that may be of interest to the user, such as local news content at the location of the user sports content for one or more favorite teams of the user, and/or other content which the user may not be aware of. With respect to the general topics feed, the gaming station 654A may include recent news related to video games, video companies, gaming hardware or software, or the like. Further, the theatre station 654B may include recent news related to Broadway in New York, NY or other theatres, famous thespians, or the like. Moreover, the music station 654C may include recent news related to various musical artists, up and coming genres of music, or the like. With respect to the personalized feed 656, the [NEWS OUTLET 1] station 656A may include news articles or news segments for “NEWS OUTLET 1” to which the user subscribes or follows. Further, the [NEWS OUTLET 2] station 656B may include news articles or news segments for “NEWS OUTLET 2” to which the user subscribes or follows. Although sources of content for each of the stations are described above, it should be understood that those sources of the content are provided for the sake of example and are not meant to be limiting.

In various implementations, and prior to any summary of content being rendered for presentation to the user via the client device 110, the user can interact with a selectable element 658 that, when selected, enables the user to specify a duration of the summary of the content. In the example of FIG. 6A, the duration of the summary is set to 10 minutes, but it should be understood that is for the sake of example and is not meant to be limiting. For instance, the user may be able to specify other durations of time over which the summary of the content should be rendered and/or a length of the summary of the content in terms of text (e.g., specify a number of words, a number of sentences, etc.). In these implementations, and assuming that a degree of summarization is utilized in generating the summary of the content, the duration of the summary specified by the user can influence the degree of summarization.

Referring specifically to FIG. 6B, assume that the user of the client device 110 selects (e.g., a touch selection, a voice selection, etc.) the gaming station 654A in the general topics feed 654. In response to receiving the selection of the gaming station 654A, a summary of content 662 that is generated based on a plurality of sources of content can be provided for presentation to the user via the client device 110. As shown in FIG. 6B, the summary of the content 662 can include, for example, “The most highly anticipated video game of the year's gameplay trailer shows off a lot of the new mechanics and features that will be in the game. For example . . . ”. In some implementations, the summary of the content 662 may be generated prior to receiving the selection of the gaming station 654A in FIG. 6A, whereas in other implementations, the summary of the content 662 may be generated in response to receiving the selection of the gaming station 654A in FIG. 6A. Notably, the summary of the content 662 can be visually rendered (e.g., as shown at the display 191 of the client device 110 in FIG. 6A) and/or audibly rendered (e.g., via speaker(s) of the client device 110). In various implementations, additional selectable elements may be provided. For example, selectable element 684, when selected, may cause the rendering of the summary of the content 662 to be paused until the user provides additional input to resume the rendering of the summary of the content 662. Further, selectable element 686, when selected, may enable the user to share the summary of the content 662 with other users (e.g., via a text message, social media message or post, email, and/or by other means) that can join in to consume the summary of the content 662 in real-time or consume at a later time at their leisure.

Referring specifically to FIG. 6C, assume that the user of the client device 110, while the summary of the content is being rendered, provides user input 664 that interrupts the rendering of the summary of the content 662. Further assume that the user input 664 is a spoken utterance (e.g., detected in response to receiving a selection of the microphone interface element 196) of “When did the latest trailer come out?”. In this example, the rendering of the summary of the content 662 can be halted (e.g., as indicated by the ellipses in the summary of the content), and optionally subsequent to rendering of a current portion of the summary of the content. Despite this interruption during the rendering of the summary of the content 662, a response 666 of “The latest trailer [deeplink to the gameplay reveal trailer 666A] was released on Feb. 9, 2023” that is responsive to the user input 664 can be generated and rendered for presentation to the user. Notably, the response 666 can include a deeplink 666A that, when selected, can cause the client device 110 to navigate to the trailer (e.g., via a web browser application or a video playback application).

In various implementations, and prior to resuming the rendering of the summary of the content 662 after a timeout period (e.g., of 3 seconds, 5 seconds, or other durations of time to enable the user to consume the response 666), various suggestion chips may be provided for presentation to the user. For instance, suggestion chip 670, when selected, can cause the timeout period to be skipped and the rendering of the summary of the content 662 to be resumed. Also, for instance, suggestion chip 672, when selected, can cause the gameplay reveal trailer 666A to be saved for later consumption by the user. Also, for instance, suggestion chip 674, when selected, can cause an additional user input embodied by the suggestion chip 674 to be submitted and an additional response that is responsive to the additional user input to be generated and rendered (e.g., in furtherance of the dialog). However, and referring specifically to FIG. 6D, assume the user does not select any of the suggestion chips. In this example, the rendering of the summary of the content 662 can automatically resume by rendering a next portion 668 of the summary of the content 662. As shown in FIG. 6D, the next portion 668 can include, for example, “These new mechanics allow users to fuse material found in the environment to one another to create new items with unique abilities . . . ”. The summary of the content 662 can continue being rendered until it is complete with the user interrupting as they please.

Although the examples of FIGS. 6A-6D are described with respect to the user selecting a particular generative radio station, it should be understood that is for the sake of example and is not meant to be limiting. Rather, it should be understood that is to illustrate various techniques contemplated herein. Further, although particular suggestion chips are described with respect to FIG. 6C, it should be understood that is for the sake of example and is not meant to be limiting. Rather, it should be understood that the suggestion chips that are presented to the user can be contextually relevant to the user input and/or the response that is responsive to the user input.

Although the examples of FIGS. 6A-6D are not described with respect to the next portion 668 of the summary of the content 662 being modified (e.g., as described with respect to FIG. 4), it should be understood that is for the sake of brevity. For instance, had the user of the client device 110 selected the suggestion chip 674 as an additional user input, an additional response would likely correspond to the next portion 668 of the summary of the content 662. As a result, the next portion 668 of the summary of the content 662 could be omitted, and the summary of the content 662 would resume at a further next portion of the summary of the content 662. Additionally, or alternatively, the next portion 668 of the summary of the content 662 could be re-generated.

Turning now to FIG. 7, a block diagram of an example computing device 710 that may optionally be utilized to perform one or more aspects of techniques described herein is depicted. In some implementations, one or more of a client device, multi-modal response system component(s) or other cloud-based software application component(s), and/or other component(s) may comprise one or more components of the example computing device 710.

Computing device 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of the methods disclosed herein, as well as to implement various components depicted in FIGS. 1 and 2.

These software modules are generally executed by processor 714 alone or in combination with other processors. Memory 725 used in the storage subsystem 724 can include a number of memories including a main random-access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem 712 may use multiple busses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, and includes: determining whether one or more triggering criteria are satisfied to generate a summary of content that is to be rendered for presentation to a user via a client device of the user; and in response to determining the one or more triggering criteria are satisfied to generate the summary of the content that is to be rendered for presentation to the user via the client device of the user: selecting, based on which of the one or more triggering criteria that are satisfied, a plurality of sources of the content to be utilized in generating the summary of the content; determining, based on one or more summarization criteria, a degree of summarization for the content; and causing the summary of the content to be generated using a large language model (LLM). Causing the summary of the content to be generated using the LLM includes: causing LLM input to be processed, using the LLM, to generate LLM output; and causing, based on the LLM output, the summary of the content to be generated. The LLM input includes at least the plurality of sources of the content and an indication of the degree of summarization for the content. The method further includes causing the summary of the content to be rendered for presentation to the user via the client device or an additional client device of the user.

These and other implementations of technology disclosed herein can optionally include one or more of the following features.

In some implementations, the plurality of sources of the content may include two or more open tabs of a web browser.

In some versions of those implementations, the one or more triggering criteria may include one or more of: a quantity criterion that indicates a quantity of the two or more open tabs of the web browser satisfies a quantity threshold, an interaction criterion that indicates interaction with the two or more open tabs of the web browser satisfies an interaction threshold, a temporal criterion that indicates a time the two or more open tabs in the web browser have been open satisfies a temporal threshold, a topic criterion that indicates a given topic of the two or more open tabs of the web browser satisfies a similarity threshold, or a situational criterion associated with a time of day or predicted activity of the user indicates a likelihood that the user will consume the two or more open tabs in the web browser satisfies a likelihood threshold.

In some further versions of those implementations, selecting the plurality of sources of the content to be utilized in generating the summary of the content based on which of the one or more triggering criteria that are satisfied may include, in response to determining the quantity criterion that indicates the two or more open tabs of the web browser satisfies the quantity threshold: selecting, based on the quantity criterion being satisfied, the two or more open tabs of the web browser that satisfy the quantity threshold as the plurality of sources of the content to be utilized in generating the summary of the content.

In additional or alternative further versions of those implementations, selecting the plurality of sources of the content to be utilized in generating the summary of the content based on which of the one or more triggering criteria that are satisfied may include, in response to determining the interaction criterion that indicates the interaction with the two or more open tabs of the web browser satisfies the interaction threshold: selecting, based on the interaction criterion being satisfied, the two or more open tabs of the web browser associated with the interaction that satisfy the interaction threshold as the plurality of sources of the content to be utilized in generating the summary of the content.

In additional or alternative further versions of those implementations, selecting the plurality of sources of the content to be utilized in generating the summary of the content based on which of the one or more triggering criteria that are satisfied may include, in response to determining the temporal criterion that indicates the time the two or more open tabs in the web browser have been open satisfies the temporal threshold: selecting, based on the quantity criterion being satisfied, the two or more open tabs of the web browser associated with the time that satisfy the temporal threshold as the plurality of sources of the content to be utilized in generating the summary of the content.

In additional or alternative further versions of those implementations, selecting the plurality of sources of the content to be utilized in generating the summary of the content based on which of the one or more triggering criteria that are satisfied may include, in response to determining the topic criterion that indicates the given topic of the two or more open tabs of the web browser satisfies the similarity threshold: selecting, based on the quantity criterion being satisfied, the two or more open tabs of the web browser associated with the given topic that satisfy the similarity threshold as the plurality of sources of the content to be utilized in generating the summary of the content.

In additional or alternative further versions of those implementations, selecting the plurality of sources of the content to be utilized in generating the summary of the content based on which of the one or more triggering criteria that are satisfied may include, in response to determining the situational criterion associated with the time of day or the predicted activity of the user indicates the likelihood that the user will consume the two or more open tabs in the web browser satisfies the likelihood threshold: selecting, based on the quantity criterion being satisfied, the two or more open tabs of the web browser associated with the likelihood that satisfy the likelihood threshold as the plurality of sources of the content to be utilized in generating the summary of the content.

In some implementations, the plurality of sources of the content may include two or more news articles from one or more news outlets.

In some versions of those implementations, the one or more triggering criteria may include one or more of: a quantity criterion that indicates a quantity of the two or more new articles from the one or more news outlets satisfies a quantity threshold, a topic criterion that indicates a given topic of the two or more new articles from the one or more news outlets satisfies a similarity threshold, or a situational criterion associated with a time of day or predicted activity of the user indicates a likelihood that the user will consume the two or more new articles from the one or more news outlets satisfies a likelihood threshold.

In some further versions of those implementations, selecting the plurality of sources of the content to be utilized in generating the summary of the content based on which of the one or more triggering criteria that are satisfied may include, in response to determining the quantity criterion that indicates the two or more new articles from the one or more news outlets satisfies the quantity threshold: selecting, based on the quantity criterion being satisfied, the two or more new articles from the one or more news outlets that satisfy the quantity threshold as the plurality of sources of the content to be utilized in generating the summary of the content.

In additional or alternative further versions of those implementations, selecting the plurality of sources of the content to be utilized in generating the summary of the content based on which of the one or more triggering criteria that are satisfied may include, in response to determining the topic criterion that indicates the given topic of the two or more new articles from the one or more news outlets satisfies the similarity threshold: selecting, based on the quantity criterion being satisfied, the two or more new articles from the one or more news outlets associated with the given topic that satisfy the similarity threshold as the plurality of sources of the content to be utilized in generating the summary of the content.

In additional or alternative further versions of those implementations, selecting the plurality of sources of the content to be utilized in generating the summary of the content based on which of the one or more triggering criteria that are satisfied may include, in response to determining the situational criterion associated with the time of day or the predicted activity of the user indicates the likelihood that the user will consume the two or more new articles from the one or more news outlets satisfies the likelihood threshold: selecting, based on the quantity criterion being satisfied, the two or more new articles from the one or more news outlets associated with the likelihood that satisfy the likelihood threshold as the plurality of sources of the content to be utilized in generating the summary of the content.

In some implementations, the one or more summarization criteria may include one or more of: a temporal duration over which the summary of the content is to be rendered for presentation to the user, a textual length of which the summary of the content is to be rendered for presentation to the user, or a level of expertise of the user of the client device with respect to a topic of the summary of the content.

In some versions of those implementations, the one or more summarization criteria may be inferred based on or more of: a quantity of the sources of the content included in the plurality of sources of the content, availability content determined based on a calendar of the user, or navigation content determined based on a predicted navigation duration of the user.

In additional or alternative versions of those implementations, the degree of summarization may vary based on a quantity of the sources of the content included in the plurality of sources of the content.

In some implementations, the summary of the content that is determined based on the LLM output may include textual content, and causing the summary of the content to be rendered for presentation to the user may include: causing the textual content to be visually rendered for presentation to the user as a transcription via a display of the client device or the additional client device.

In some versions of those implementations, causing the summary of the content to be rendered for presentation to the user further may include: causing the textual content to be processed, using a text-to-speech (TTS) model, to generate audible content corresponding to the textual content; and causing the audible content to be audibly rendered for presentation to the user as an audio stream via one or more speakers of the client device or the additional client device.

In some implementations, the summary of the content that is determined based on the LLM output may include textual content, and causing the summary of the content to be rendered for presentation to the user may include: causing the textual content to be processed, using a text-to-speech (TTS) model, to generate audible content corresponding to the textual content; and causing the audible content to be audibly rendered for presentation to the user as an audio stream via one or more speakers of the client device or the additional client device.

In some implementations, a method implemented by one or more processors is provided, and includes: receiving user input to generate a summary of content, wherein the user input is received via a client device of a user; selecting, based on the user input, a plurality of sources of the content to be utilized in generating the summary of the content; determining, based on one or more summarization criteria, a degree of summarization for the content; and causing the summary of the content to be generated using a large language model (LLM). Causing the summary of the content to be generated using the LLM includes: causing LLM input to be processed, using the LLM, to generate LLM output; and causing, based on the LLM output, the summary of the content to be generated. The LLM input may include at least the plurality of sources of the content and an indication of the degree of summarization for the content. The method further includes causing the summary of the content to be rendered for presentation to the user via the client device or an additional client device of the user.

These and other implementations of technology disclosed herein can optionally include one or more of the following features.

In some implementations, the user input may include an indication of the plurality of sources of the content to be utilized in generating the summary of the content.

In some implementations, the plurality of sources of the content may include one or more of: two or more open tabs of a web browser, or two or more news articles from one or more news outlets.

In some implementations, the one or more summarization criteria may include one or more of: a temporal duration over which the summary of the content is to be rendered for presentation to the user, a textual length of which the summary of the content is to be rendered for presentation to the user, or a level of expertise of the user of the client device with respect to a topic of the summary of the content.

In some versions of those implementations, the one or more summarization criteria may be included in the user input or additional user input that is received via the client device.

In additional or alternative versions of those implementations, the one or more summarization criteria may be inferred based on or more of: a quantity of the sources of the content included in the plurality of sources of the content, availability content determined based on a calendar of the user, navigation content determined based on a predicted navigation duration of the user.

In additional or alternative versions of those implementations, the degree of summarization may vary based on a quantity of the sources of the content included in the plurality of sources of the content.

In some implementations, the summary of the content that is determined based on the LLM output may include textual content, and causing the summary of the content to be rendered for presentation to the user may include: causing the textual content to be visually rendered for presentation to the user as a transcription via a display of the client device or the additional client device.

In some versions of those implementations, causing the summary of the content to be rendered for presentation to the user further may include: causing the textual content to be processed, using a text-to-speech (TTS) model, to generate audible content corresponding to the textual content; and causing the audible content to be audibly rendered for presentation to the user as an audio stream via one or more speakers of the client device or the additional client device.

In some implementations, the summary of the content that is determined based on the LLM output may include textual content, and causing the summary of the content to be rendered for presentation to the user may include: causing the textual content to be processed, using a text-to-speech (TTS) model, to generate audible content corresponding to the textual content; and causing the audible content to be audibly rendered for presentation to the user as an audio stream via one or more speakers of the client device or the additional client device.

In some implementations, a method implemented by one or more processors is provided, and includes: selecting a plurality of sources of content to be utilized in generating a summary of content that is to be rendered for presentation to a user of a client device; and causing the summary of the content to be generated using a large language model (LLM). Causing the summary of the content to be generated using the LLM includes: causing LLM input to be processed, using the LLM, to generate LLM output, wherein the LLM input includes at least the plurality of sources of the content; and causing, based on the LLM output, the summary of the content to be generated. The method further includes causing the summary of the content to be rendered for presentation to the user via the client device; and while the summary of the content is being rendered for presentation to the user via the client device: receiving user input that interrupts the summary of the content being rendered, wherein the user input is received via the client device of the user; causing the rendering of the summary of the content to be halted; and causing, a response that is responsive to the user input to be generated using the LLM. Causing the response that is responsive to the user input to be generated using the LLM includes: causing additional LLM input to be processed, using the LLM, to generate additional LLM output, wherein the additional LLM input includes at least the user input; and causing, based on the additional LLM output, the response to be generated. The method further includes, and while the summary of the content is being rendered for presentation to the user via the client device: causing the response to be rendered for presentation to the user via the client device; and causing the rendering of the summary of the content to be resumed.

These and other implementations of technology disclosed herein can optionally include one or more of the following features.

In some implementations, the method further includes, prior to causing the rendering of the summary of the content to be halted: causing a current portion of the summary of the content to finish being rendered for presentation to the user via the client device; and causing a next portion of the summary of the content, that follows the current portion of the summary of the content, to be bookmarked.

In some versions of those implementations, causing the rendering of the summary of the content to be resumed may include: causing the next portion of the summary of the content, that follows the current portion of the summary of the content, and any remaining portions of the summary of the content to be rendered for presentation to the user via the client device.

In additional or alternative versions of those implementations, the method may further include: determining, based on the user input and/or the response that is responsive to the user input, whether to cause the next portion of the summary of the content and/or any remaining portions of the summary to be re-generated; and in response to determining to cause the next portion of the summary of the content and/or any of the remaining portions of the summary to be re-generated based on the user input and/or the response that is responsive to the user input: causing further additional LLM input to be processed, using the LLM, to generate further additional LLM output, wherein the further additional LLM input includes at least the plurality of sources of the content, the user input, and the response that is responsive to the user input; and causing, based on the further additional LLM output, the next portion of the summary of the content and/or any of the remaining portions of the summary to be re-generated.

In some further versions of those implementations, causing the rendering of the summary of the content to be resumed may include: causing the next portion of the summary of the content, that follows the current portion of the summary of the content, and any of the remaining portions of the summary of the content, that were re-generated, to be rendered for presentation to the user via the client device.

In additional or alternative further versions of those implementations, determining to cause the next portion of the summary of the content and/or any of the remaining portions of the summary to be re-generated based on the user input and/or the response that is responsive to the user input may include: determining that the user input and/or the response that is responsive to the user input includes corresponding content that is included in the next portion of the summary of the content, that follows the current portion of the summary of the content, and/or any of the remaining portions of the summary of the content.

In additional or alternative versions of those implementations, the method may further include: determining, based on the user input and/or the response that is responsive to the user input, whether to omit the next portion of the summary of the content and/or any remaining portions of the summary in resuming the rendering of the summary of the content; and in response to determining to omit the next portion of the summary of the content and/or any of the remaining portions of the summary in resuming the rendering of the summary of the content based on the user input and/or the response that is responsive to the user input: causing the next portion of the summary of the content and/or any of the remaining portions of the summary to be omitted in resuming the rendering of the summary of the content.

In some further versions of those implementations, causing the rendering of the summary of the content to be resumed may include: causing the next portion of the summary of the content, that follows the current portion of the summary of the content, and any of the remaining portions of the summary of the content, that were not omitted from the summary of the content, to be rendered for presentation to the user via the client device.

In some additional or alternative further versions of those implementations, determining to omit the next portion of the summary of the content and/or any of the remaining portions of the summary in resuming the rendering of the summary of the content based on the user input and/or the response that is responsive to the user input may include: determining that the user input and/or the response that is responsive to the user input includes corresponding content that is included in the next portion of the summary of the content, that follows the current portion of the summary of the content, and/or any of the remaining portions of the summary of the content.

In some implementations, the summary of the content that is determined based on the LLM output includes textual content, and causing the summary of the content to be rendered for presentation to the user may include: causing the textual content to be visually rendered for presentation to the user as a transcription via a display of the client device.

In some further versions of those implementations, causing the summary of the content to be rendered for presentation to the user further may include: causing the textual content to be processed, using a text-to-speech (TTS) model, to generate audible content corresponding to the textual content; and causing the audible content to be audibly rendered for presentation to the user as an audio stream via one or more speakers of the client device.

In some implementations, the summary of the content that is determined based on the LLM output may include textual content, and causing the summary of the content to be rendered for presentation to the user may include: causing the textual content to be processed, using a text-to-speech (TTS) model, to generate audible content corresponding to the textual content; and causing the audible content to be audibly rendered for presentation to the user as an audio stream via one or more speakers of the client device or the additional client device.

In some implementations, a method implemented by one or more processors is provided, and includes: processing one or more client device signals that are associated with a client device of a user; selecting, based on processing the one or more client device signals that are associated with the client device, a plurality of sources of the content to be utilized in generating a summary of content that is to be rendered for presentation to the user via the client device; and causing the summary of the content to be generated using a large language model (LLM). Causing the summary of the content to be generated using the LLM may include: causing LLM input to be processed, using the LLM, to generate LLM output; and causing, based on the LLM output, the summary of the content to be generated. The LLM input may include at least the plurality of sources of the content and an indication of the degree of summarization for the content. The method further includes causing the summary of the content to be rendered for presentation to the user via the client device or an additional client device of the user.

These and other implementations of technology disclosed herein can optionally include one or more of the following features.

In some implementations, the plurality of sources of the content may include two or more open tabs of a web browser.

In some versions of those implementations, the one or more client device signals that are associated with the client device may include one or more of: a quantity of the two or more open tabs of the web browser satisfying a quantity threshold, interaction with the two or more open tabs of the web browser satisfying an interaction threshold, a time the two or more open tabs in the web browser have been open satisfying a temporal threshold, a given topic of the two or more open tabs of the web browser satisfying a similarity threshold, or a time of day or predicted activity of the user indicates a likelihood that the user will consume the two or more open tabs in the web browser satisfying a likelihood threshold.

In some implementations, causing the summary of the content to be generated using the LLM may be in response to receiving user input, from the user of the client device, to generate the summary of the content.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods. Some implementations also include a computer program product including instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
determining whether one or more triggering criteria are satisfied to generate a summary of content that is to be rendered for presentation to a user via a client device of the user;
in response to determining the one or more triggering criteria are satisfied to generate the summary of the content that is to be rendered for presentation to the user via the client device of the user:
selecting, based on which of the one or more triggering criteria that are satisfied, a plurality of sources of the content to be utilized in generating the summary of the content;
determining, based on one or more summarization criteria, a degree of summarization for the content;
causing the summary of the content to be generated using a large language model (LLM), wherein causing the summary of the content to be generated using the LLM comprises:
causing LLM input to be processed, using the LLM, to generate LLM output, wherein the LLM input includes at least the plurality of sources of the content and an indication of the degree of summarization for the content; and
causing, based on the LLM output, the summary of the content to be generated; and
causing the summary of the content to be rendered for presentation to the user via the client device or an additional client device of the user.

2. The method of claim 1, wherein the plurality of sources of the content include two or more open tabs of a web browser.

3. The method of claim 2, wherein the one or more triggering criteria comprise one or more of:
a quantity criterion that indicates a quantity of the two or more open tabs of the web browser satisfies a quantity threshold,
an interaction criterion that indicates interaction with the two or more open tabs of the web browser satisfies an interaction threshold,
a temporal criterion that indicates a time the two or more open tabs in the web browser have been open satisfies a temporal threshold,
a topic criterion that indicates a given topic of the two or more open tabs of the web browser satisfies a similarity threshold, or
a situational criterion associated with a time of day or predicted activity of the user indicates a likelihood that the user will consume the two or more open tabs in the web browser satisfies a likelihood threshold.

4. The method of claim 3, wherein selecting the plurality of sources of the content to be utilized in generating the summary of the content based on which of the one or more triggering criteria that are satisfied comprises:
in response to determining the quantity criterion that indicates the two or more open tabs of the web browser satisfies the quantity threshold:
selecting, based on the quantity criterion being satisfied, the two or more open tabs of the web browser that satisfy the quantity threshold as the plurality of sources of the content to be utilized in generating the summary of the content.

5. The method of claim 3, wherein selecting the plurality of sources of the content to be utilized in generating the summary of the content based on which of the one or more triggering criteria that are satisfied comprises:
in response to determining the interaction criterion that indicates the interaction with the two or more open tabs of the web browser satisfies the interaction threshold:
selecting, based on the interaction criterion being satisfied, the two or more open tabs of the web browser associated with the interaction that satisfy the interaction threshold as the plurality of sources of the content to be utilized in generating the summary of the content.

6. The method of claim 3, wherein selecting the plurality of sources of the content to be utilized in generating the summary of the content based on which of the one or more triggering criteria that are satisfied comprises:
in response to determining the temporal criterion that indicates the time the two or more open tabs in the web browser have been open satisfies the temporal threshold:
selecting, based on the quantity criterion being satisfied, the two or more open tabs of the web browser associated with the time that satisfy the temporal threshold as the plurality of sources of the content to be utilized in generating the summary of the content.

7. The method of claim 3, wherein selecting the plurality of sources of the content to be utilized in generating the summary of the content based on which of the one or more triggering criteria that are satisfied comprises:
in response to determining the topic criterion that indicates the given topic of the two or more open tabs of the web browser satisfies the similarity threshold:
selecting, based on the quantity criterion being satisfied, the two or more open tabs of the web browser associated with the given topic that satisfy the similarity threshold as the plurality of sources of the content to be utilized in generating the summary of the content.

8. The method of claim 3, wherein selecting the plurality of sources of the content to be utilized in generating the summary of the content based on which of the one or more triggering criteria that are satisfied comprises:
in response to determining the situational criterion associated with the time of day or the predicted activity of the user indicates the likelihood that the user will consume the two or more open tabs in the web browser satisfies the likelihood threshold:
selecting, based on the quantity criterion being satisfied, the two or more open tabs of the web browser associated with the likelihood that satisfy the likelihood threshold as the plurality of sources of the content to be utilized in generating the summary of the content.

9. The method of claim 1, wherein the plurality of sources of the content include two or more news articles from one or more news outlets.

10. The method of claim 9, wherein the one or more triggering criteria comprise one or more of:
a quantity criterion that indicates a quantity of the two or more new articles from the one or more news outlets satisfies a quantity threshold,
a topic criterion that indicates a given topic of the two or more new articles from the one or more news outlets satisfies a similarity threshold, or
a situational criterion associated with a time of day or predicted activity of the user indicates a likelihood that the user will consume the two or more new articles from the one or more news outlets satisfies a likelihood threshold.

11. The method of claim 10, wherein selecting the plurality of sources of the content to be utilized in generating the summary of the content based on which of the one or more triggering criteria that are satisfied comprises:
in response to determining the quantity criterion that indicates the two or more new articles from the one or more news outlets satisfies the quantity threshold:
selecting, based on the quantity criterion being satisfied, the two or more new articles from the one or more news outlets that satisfy the quantity threshold as the plurality of sources of the content to be utilized in generating the summary of the content.

12. The method of claim 10, wherein selecting the plurality of sources of the content to be utilized in generating the summary of the content based on which of the one or more triggering criteria that are satisfied comprises:
in response to determining the topic criterion that indicates the given topic of the two or more new articles from the one or more news outlets satisfies the similarity threshold:
selecting, based on the quantity criterion being satisfied, the two or more new articles from the one or more news outlets associated with the given topic that satisfy the similarity threshold as the plurality of sources of the content to be utilized in generating the summary of the content.

13. The method of claim 10, wherein selecting the plurality of sources of the content to be utilized in generating the summary of the content based on which of the one or more triggering criteria that are satisfied comprises:
in response to determining the situational criterion associated with the time of day or the predicted activity of the user indicates the likelihood that the user will consume the two or more new articles from the one or more news outlets satisfies the likelihood threshold:
selecting, based on the quantity criterion being satisfied, the two or more new articles from the one or more news outlets associated with the likelihood that satisfy the likelihood threshold as the plurality of sources of the content to be utilized in generating the summary of the content.

14. The method of claim 1, wherein the one or more summarization criteria comprise one or more of: a temporal duration over which the summary of the content is to be rendered for presentation to the user, a textual length of which the summary of the content is to be rendered for presentation to the user, or a level of expertise of the user of the client device with respect to a topic of the summary of the content.

15. The method of claim 14, wherein the one or more summarization criteria are inferred based on or more of: a quantity of the sources of the content included in the plurality of sources of the content, availability content determined based on a calendar of the user, or navigation content determined based on a predicted navigation duration of the user.

16. The method of claim 14, wherein the degree of summarization varies based on a quantity of the sources of the content included in the plurality of sources of the content.

17. A method implemented by one or more processors, the method comprising:
receiving user input to generate a summary of content, wherein the user input is received via a client device of a user;
selecting, based on the user input, a plurality of sources of the content to be utilized in generating the summary of the content;
determining, based on one or more summarization criteria, a degree of summarization for the content;
causing the summary of the content to be generated using a large language model (LLM), wherein causing the summary of the content to be generated using the LLM comprises:
causing LLM input to be processed, using the LLM, to generate LLM output, wherein the LLM input includes at least the plurality of sources of the content and an indication of the degree of summarization for the content; and
causing, based on the LLM output, the summary of the content to be generated; and
causing the summary of the content to be rendered for presentation to the user via the client device or an additional client device of the user.

18. The method of claim 17, wherein the user input includes an indication of the plurality of sources of the content to be utilized in generating the summary of the content.

19. The method of claim 17, wherein the one or more summarization criteria are included in the user input or additional user input that is received via the client device.

20. A method implemented by one or more processors, the method comprising:
selecting a plurality of sources of content to be utilized in generating a summary of content that is to be rendered for presentation to a user of a client device;
causing the summary of the content to be generated using a large language model (LLM), wherein causing the summary of the content to be generated using the LLM comprises:
causing LLM input to be processed, using the LLM, to generate LLM output, wherein the LLM input includes at least the plurality of sources of the content; and
causing, based on the LLM output, the summary of the content to be generated;
causing the summary of the content to be rendered for presentation to the user via the client device; and
while the summary of the content is being rendered for presentation to the user via the client device:
receiving user input that interrupts the summary of the content being rendered, wherein the user input is received via the client device of the user;
causing the rendering of the summary of the content to be halted;
causing, a response that is responsive to the user input to be generated using the LLM, wherein causing the response that is responsive to the user input to be generated using the LLM comprises:
causing additional LLM input to be processed, using the LLM, to generate additional LLM output, wherein the additional LLM input includes at least the user input; and
causing, based on the additional LLM output, the response to be generated;
causing the response to be rendered for presentation to the user via the client device; and
causing the rendering of the summary of the content to be resumed.
